(19) United States
(12) Patent Application Publication
(10) Pub. No.: US 2026/0245280 A1
(43) Pub. Date: Aug. 20, 2026

(54) METHOD AND APPARATUS FOR 3D ASSET TRANSCODING OF AVATAR FORMAT AND ANIMATION CONTROLS IN REAL TIME COMMUNICATION OVER IMS

(71) Applicant: TENCENT AMERICA LLC, Palo Alto, CA (US)

(72) Inventor: Stephan WENGER, Hillsborough, CA (US)

(73) Assignee: TENCENT AMERICA LLC, Palo Alto, CA (US)

(21) Appl. No.: 19/457,426

(22) Filed: Jan. 23, 2026

Related U.S. Application Data
(60) Provisional application No. 63/760,391, filed on Feb. 19, 2025.

(51) Int. Cl. G06T 13/40; G06T 9/00; H04L 65/1016

(52) U.S. Cl. CPC G06T 13/40; G06T 9/00; H04L 65/1016; G06T 2210/32

(57) ABSTRACT

There is provided a method and apparatus for transcoding an avatar base representation format in an internet protocol (IP) multimedia subsystem (IMS) architecture, and including transcoding the avatar base representation format in a media function (MF) of the IMS architecture, implementing a delivery of the transcoded avatar base representation format to at least one user equipment (UE), generating animation data based on source data including any of audio, video, and text, and the animation data representing animation of a base avatar represented by the transcoded avatar base representation format.

### CROSS REFERENCE TO RELATED APPLICATION

The present application claims priority to provisional application US 63/760,391 filed on February 19, 2025, the contents of which are hereby expressly incorporated by reference, in its entirety, into the present application.

### BACKGROUND

### 1. Field

This disclosure defines methods and improvements for transcoding avatar formats and their associated animation data in 5G real-time communication in an internet protocol (IP) multimedia subsystem (IMS).

### 2. Description of Related Art

An IMS application is an application that uses an IMS communication service(s) in order to provide a specific service to the end-user. An IMS application utilizes the IMS communication service(s) as they are specified without extending the definition of the IMS communication service(s). And an IMS communication service is a type of communication defined by a service definition that specifies the rules and procedures and allowed medias for a specific type of communication and that utilizes the IMS enablers.

3GPP TR 26.813 defines the Avatar formats and their system integration into real-time communication services over IMS. While the technical report acknowledges the existence of several representation formats it only addresses the end-to-end communication using the same avatar representation format and does not take advantage of the IMS infrastructure to enable transcoding of formats when considering devices with different capabilities. The architecture mapping of avatar communication defined in 3GPP TR 26.813 describes the network functions and mapping avatar functions to IMS data channel (DC) Architecture.

Also, while TR 26.813 defines the workflows and procedures of such a service, the technical report does not address the necessary creation of the Avatar-based presentation in a dedicated generation session prior to a real time communication session.

And for those reasons, which should not be taken as admitted prior art and are not presented as such, there is a desire for technical solutions to such problems that arose in video coding technology. And by new embodiments disclosed herein, there are advantageous mechanisms for transcoding avatar formats and their associated animation data in 5G real-time communication in IMS.

### SUMMARY

There is provided a method for transcoding an avatar base representation format in an internet protocol (IP) multimedia subsystem (IMS) architecture, the method performed by one or more processors and including: transcoding the avatar base representation format in a media function (MF) of the IMS architecture; implementing a delivery of the transcoded avatar base representation format to at least one user equipment (UE); and generating animation data based on source data including any of audio, video, and text, and the animation data representing animation of a base avatar represented by the transcoded avatar base representation format.

There is provided a system for transcoding an avatar base representation format in an internet protocol (IP) multimedia subsystem (IMS) architecture, the system being implemented by one or more processors configured to: transcode the avatar base representation format in a media function (MF) of the IMS architecture; implement a delivery of the transcoded avatar base representation format to at least one user equipment (UE); and generate animation data based on source data including any of audio, video, and text, and the animation data representing animation of a base avatar represented by the transcoded avatar base representation format.

There is provided a non-transitory, computer-readable recording medium storing instructions, for transcoding an avatar base representation format in an internet protocol (IP) multimedia subsystem (IMS) architecture, which, when executed, control one or more processors to implement: transcoding the avatar base representation format in a media function (MF) of the IMS architecture; implementing a delivery of the transcoded avatar base representation format to at least one user equipment (UE); and generating animation data based on source data including any of audio, video, and text, and the animation data representing animation of a base avatar represented by the transcoded avatar base representation format.

The transcoded avatar base representation format may be supported by the at least one UE.

Transcoding the avatar base representation format may include also transcoding animation controls in the MF of the IMS architecture.

The transcoded animation controls may be in a mezzanine format.

The MF may be of an Nmf service-based interface exhibited by the IMS architecture.

Transcoding the avatar base representation format may include transcoding between two avatar representation formats.

Generating the animation data may include transcoding between two animation formats associated to at least one of the two avatar representation formats.

### BRIEF DESCRIPTION OF THE DRAWINGS

Further features, nature, and various advantages of the disclosed subject matter will be more apparent from the following detailed description and the accompanying drawings in which:

FIG. 1 is a simplified block diagram of a communication system in accordance with embodiments herein;

FIG. 2 is a simplified illustration of an encoder and decoder environment in accordance with embodiments herein;

FIG. 3 is a simplified block diagram regarding decoders in accordance with embodiments herein;

FIG. 4 is a simplified block diagram regarding encoders in accordance with embodiments herein;

FIG. 5 is a simplified block diagram of an AR system in accordance with embodiments herein;

FIG. 6 is a simplified block diagram in a 5G system in accordance with embodiments herein;

FIG. 7 is a simplified block diagram in a 5G UE environment in accordance with embodiments herein;

FIG. 8 is a simplified block diagram in an EDGAR environment in accordance with embodiments herein;

FIG. 9 is a simplified block diagram in an EDGAR UE environment in accordance with embodiments herein;

FIG. 10 is a simplified diagram of an AR use in accordance with embodiments herein;

FIG. 11 is a simplified block diagram of a mixed AR and non AR system in accordance with embodiments herein;

FIG. 12 is a simplified block diagram of a non-AR UE in accordance with embodiments herein;

FIG. 13 is a simplified block and timing diagram in accordance with embodiments herein;

FIG. 14 is a simplified block diagram of a 5GMS architecture in accordance with embodiments herein;

FIG. 15 is a simplified block diagram of content steering and distribution inside a trusted domain in accordance with embodiments herein;

FIG. 16 is a simplified block diagram of content steering outside of a trusted domain with mixed distribution inside and outside that domain in accordance with embodiments herein;

FIG. 17 is a simplified block diagram of content steering outside of a distribution network inside the trusted domain in accordance with embodiments herein;

FIG. 18 is a simplified block diagram of content steering inside and some distribution networks outside of the trusted domain in accordance with embodiments herein;

FIG. 19 shows examples of mapping of avatar functions and avatar generation sessions in accordance with embodiments herein;

FIG. 20 shows an example regarding a network centric call setup and capability negotiation flow in accordance with embodiments herein;

FIG. 21 shows an example regarding a UE centric call setup and capability negotiation flow in accordance with embodiments herein;

FIGS. 22 and 23 show examples of avatar delivery and animation in accordance with embodiments herein; and

FIG. 24 is a schematic illustration of example computer system components in accordance with embodiments herein.

### DETAILED DESCRIPTION

The proposed features discussed below may be used separately or combined in any order. Further, the embodiments may be implemented by processing circuitry (e.g., one or more processors or one or more integrated circuits). In one example, the one or more processors execute a program that is stored in a non-transitory computer-readable medium.

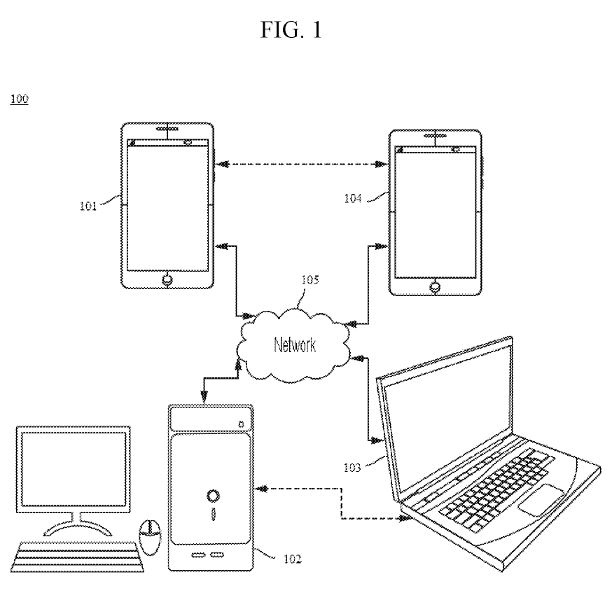

FIG. 1 illustrates a simplified block diagram of a communication system 100 according to an embodiment of the present disclosure. The communication system 100 may include at least two terminals 102 and 103 interconnected via a network 105. For unidirectional transmission of data, a first terminal 103 may code video data at a local location for transmission to the other terminal 102 via the network 105. The second terminal 102 may receive the coded video data of the other terminal from the network 105, decode the coded data and display the recovered video data. Unidirectional data transmission may be common in media serving applications and the like.

FIG. 1 illustrates a second pair of terminals 101 and 104 provided to support bidirectional transmission of coded video that may occur, for example, during videoconferencing. For bidirectional transmission of data, each terminal 101 and 104 may code video data captured at a local location for transmission to the other terminal via the network 105. Each terminal 101 and 104 also may receive the coded video data transmitted by the other terminal, may decode the coded data and may display the recovered video data at a local display device.

In FIG. 1, the terminals 101, 102, 103 and 104 may be illustrated as servers, personal computers and smart phones but the principles of the present disclosure are not so limited. Embodiments of the present disclosure find application with laptop computers, tablet computers, media players and/or dedicated video conferencing equipment. The network 105 represents any number of networks that convey coded video data among the terminals 101, 102, 103 and 104, including for example wireline and/or wireless communication networks. The communication network 105 may exchange data in circuit-switched and/or packet-switched channels. Representative networks include telecommunications networks, local area networks, wide area networks and/or the Internet. For the purposes of the present discussion, the architecture and topology of the network 105 may be immaterial to the operation of the present disclosure unless explained herein below.

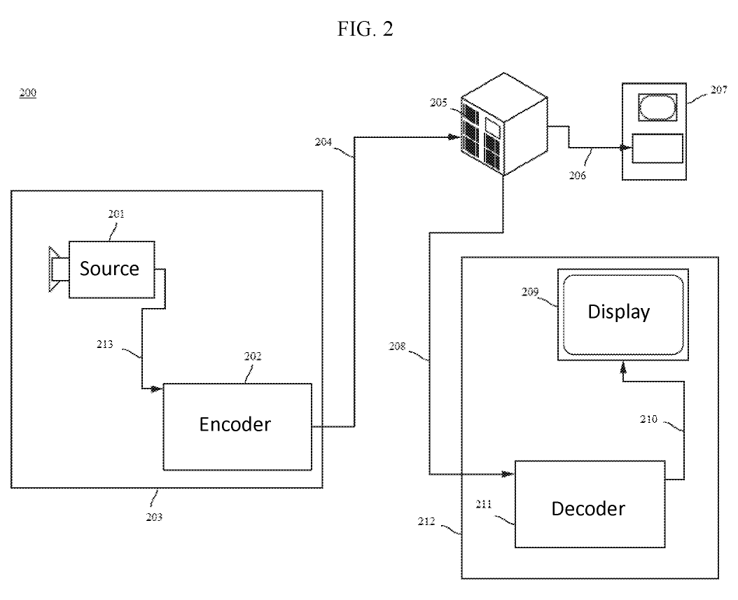

FIG. 2 illustrates, as an example for an application for the disclosed subject matter, the placement of a video encoder and decoder in a streaming environment. The disclosed subject matter can be equally applicable to other video enabled applications, including, for example, video conferencing, digital TV, storing of compressed video on digital media including CD, DVD, memory stick and the like, and so on.

A streaming system may include a capture subsystem 203, that can include a video source 201, for example a digital camera, creating, for example, an uncompressed video sample stream 213. That sample stream 213 may be emphasized as a high data volume when compared to encoded video bitstreams and can be processed by an encoder 202 coupled to the camera 201. The encoder 202 can include hardware, software, or a combination thereof to enable or implement aspects of the disclosed subject matter as described in more detail below. The encoded video bitstream 204, which may be emphasized as a lower data volume when compared to the sample stream, can be stored on a streaming server 205 for future use. One or more streaming clients 212 and 207 can access the streaming server 205 to retrieve copies 208 and 206 of the encoded video bitstream 204. A client 212 can include a video decoder 211 which decodes the incoming copy of the encoded video bitstream 208 and creates an outgoing video sample stream 210 that can be rendered on a display 209 or other rendering device (not depicted). In some streaming systems, the video bitstreams 204, 206 and 208 can be encoded according to certain video coding/compression standards. Examples of those standards are noted above and described further herein.

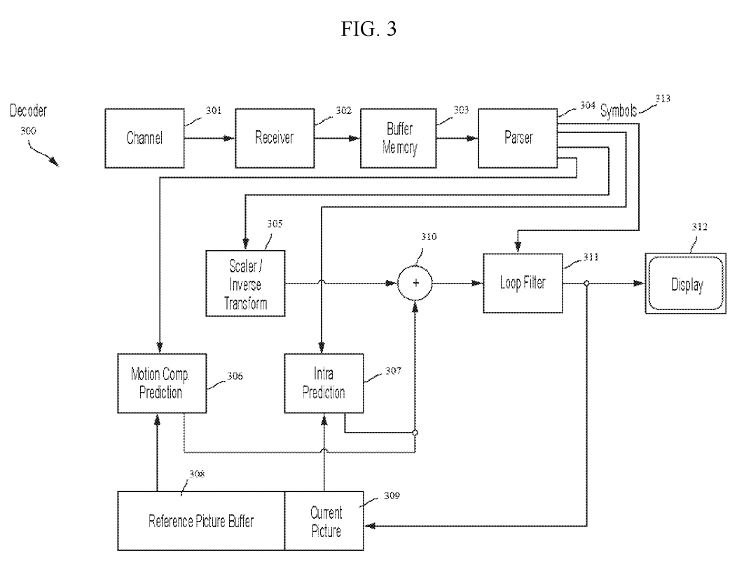

FIG. 3 may be a functional block diagram of a video decoder 300 according to an embodiment of the present invention.

A receiver 302 may receive one or more codec video sequences to be decoded by the decoder 300; in the same or another embodiment, one coded video sequence at a time, where the decoding of each coded video sequence is independent from other coded video sequences. The coded video sequence may be received from a channel 301, which may be a hardware/software link to a storage device which stores the encoded video data. The receiver 302 may receive the encoded video data with other data, for example, coded audio data and/or ancillary data streams, that may be forwarded to their respective using entities (not depicted). The receiver 302 may separate the coded video sequence from the other data. To combat network jitter, a buffer memory 303 may be coupled in between receiver 302 and entropy decoder / parser 304 (“parser” henceforth). When receiver 302 is receiving data from a store/forward device of sufficient bandwidth and controllability, or from an isosychronous network, the buffer 303 may not be needed, or can be small. For use on best effort packet networks such as the Internet, the buffer 303 may be required, can be comparatively large and can advantageously of adaptive size.

The video decoder 300 may include a parser 304 to reconstruct symbols 313 from the entropy coded video sequence. Categories of those symbols include information used to manage operation of the decoder 300, and potentially information to control a rendering device such as a display 312 that is not an integral part of the decoder but can be coupled to it. The control information for the rendering device(s) may be in the form of Supplementary Enhancement Information (SEI messages) or Video Usability Information parameter set fragments (not depicted). The parser 304 may parse / entropy-decode the coded video sequence received. The coding of the coded video sequence can be in accordance with a video coding technology or standard, and can follow principles well known to a person skilled in the art, including variable length coding, Huffman coding, arithmetic coding with or without context sensitivity, and so forth. The parser 304 may extract from the coded video sequence, a set of subgroup parameters for at least one of the subgroups of pixels in the video decoder, based upon at least one parameters corresponding to the group. Subgroups can include Groups of Pictures (GOPs), pictures, tiles, slices, macroblocks, Coding Units (CUs), blocks, Transform Units (TUs), Prediction Units (PUs) and so forth. The entropy decoder / parser may also extract from the coded video sequence information such as transform coefficients, quantizer parameter values, motion vectors, and so forth.

The parser 304 may perform entropy decoding / parsing operation on the video sequence received from the buffer 303, so to create symbols 313. The parser 304 may receive encoded data, and selectively decode particular symbols 313. Further, the parser 304 may determine whether the particular symbols 313 are to be provided to a Motion Compensation Prediction unit 306, a scaler / inverse transform unit 305, an Intra Prediction Unit 307, or a loop filter 311.

Reconstruction of the symbols 313 can involve multiple different units depending on the type of the coded video picture or parts thereof (such as: inter and intra picture, inter and intra block), and other factors. Which units are involved, and how, can be controlled by the subgroup control information that was parsed from the coded video sequence by the parser 304. The flow of such subgroup control information between the parser 304 and the multiple units below is not depicted for clarity.

Beyond the functional blocks already mentioned, decoder 300 can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler / inverse transform unit 305. The scaler / inverse transform unit 305 receives quantized transform coefficient as well as control information, including which transform to use, block size, quantization factor, quantization scaling matrices, etc. as symbol(s) 313 from the parser 304. It can output blocks comprising sample values, that can be input into aggregator 310.

In some cases, the output samples of the scaler / inverse transform 305 can pertain to an intra coded block; that is: a block that is not using predictive information from previously reconstructed pictures, but can use predictive information from previously reconstructed parts of the current picture. Such predictive information can be provided by an intra picture prediction unit 307. In some cases, the intra picture prediction unit 307 generates a block of the same size and shape of the block under reconstruction, using surrounding already reconstructed information fetched from the current (partly reconstructed) picture 309. The aggregator 310, in some cases, adds, on a per sample basis, the prediction information the intra prediction unit 307 has generated to the output sample information as provided by the scaler / inverse transform unit 305.

In other cases, the output samples of the scaler / inverse transform unit 305 can pertain to an inter coded, and potentially motion compensated block. In such a case, a Motion Compensation Prediction unit 306 can access reference picture memory 308 to fetch samples used for prediction. After motion compensating the fetched samples in accordance with the symbols 313 pertaining to the block, these samples can be added by the aggregator 310 to the output of the scaler / inverse transform unit (in this case called the residual samples or residual signal) so to generate output sample information. The addresses within the reference picture memory form where the motion compensation unit fetches prediction samples can be controlled by motion vectors, available to the motion compensation unit in the form of symbols 313 that can have, for example X, Y, and reference picture components. Motion compensation also can include interpolation of sample values as fetched from the reference picture memory when sub-sample exact motion vectors are in use, motion vector prediction mechanisms, and so forth.

The output samples of the aggregator 310 can be subject to various loop filtering techniques in the loop filter unit 311. Video compression technologies can include in-loop filter technologies that are controlled by parameters included in the coded video bitstream and made available to the loop filter unit 311 as symbols 313 from the parser 304, but can also be responsive to meta-information obtained during the decoding of previous (in decoding order) parts of the coded picture or coded video sequence, as well as responsive to previously reconstructed and loop-filtered sample values.

The output of the loop filter unit 311 can be a sample stream that can be output to the display 312, which may be a render device, as well as stored in the reference picture memory 557 for use in future inter-picture prediction.

Certain coded pictures, once fully reconstructed, can be used as reference pictures for future prediction. Once a coded picture is fully reconstructed and the coded picture has been identified as a reference picture (by, for example, parser 304), the current reference picture 309 can become part of the reference picture buffer 308, and a fresh current picture memory can be reallocated before commencing the reconstruction of the following coded picture.

The video decoder 300 may perform decoding operations according to a predetermined video compression technology that may be documented in a standard, such as ITU-T Rec. H.265. The coded video sequence may conform to a syntax specified by the video compression technology or standard being used, in the sense that it adheres to the syntax of the video compression technology or standard, as specified in the video compression technology document or standard and specifically in the profiles document therein. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver 302 may receive additional (redundant) data with the encoded video. The additional data may be included as part of the coded video sequence(s). The additional data may be used by the video decoder 300 to properly decode the data and/or to more accurately reconstruct the original video data. Additional data can be in the form of, for example, temporal, spatial, or signal-to-noise ratio (SNR) enhancement layers, redundant slices, redundant pictures, forward error correction codes, and so on.

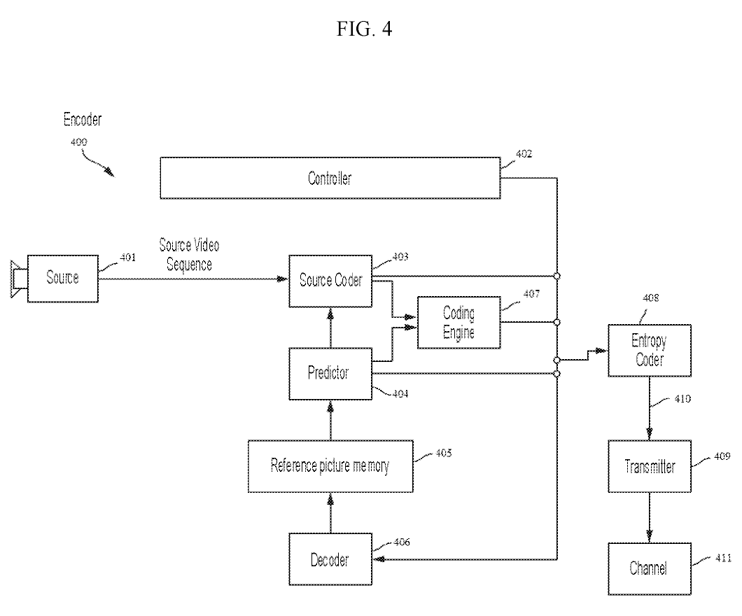

FIG. 4 may be a functional block diagram of a video encoder 400 according to an embodiment of the present disclosure.

The encoder 400 may receive video samples from a video source 401 (that is not part of the encoder) that may capture video image(s) to be coded by the encoder 400.

The video source 401 may provide the source video sequence to be coded by the encoder (303) in the form of a digital video sample stream that can be of any suitable bit depth (for example: 8 bit, 10 bit, 12 bit, …), any colorspace (for example, BT.601 Y CrCB, RGB, …) and any suitable sampling structure (for example Y CrCb 4:2:0, Y CrCb 4:4:4). In a media serving system, the video source 401 may be a storage device storing previously prepared video. In a videoconferencing system, the video source 401 may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. A person skilled in the art can readily understand the relationship between pixels and samples. The description below focuses on samples.

According to an embodiment, the encoder 400 may code and compress the pictures of the source video sequence into a coded video sequence 410 in real time or under any other time constraints as required by the application. Enforcing appropriate coding speed is one function of Controller 402. Controller controls other functional units as described below and is functionally coupled to these units. The coupling is not depicted for clarity. Parameters set by controller can include rate control related parameters (picture skip, quantizer, lambda value of rate-distortion optimization techniques, …), picture size, group of pictures (GOP) layout, maximum motion vector search range, and so forth. A person skilled in the art can readily identify other functions of controller 402 as they may pertain to video encoder 400 optimized for a certain system design.

Some video encoders operate in what a person skilled in the art readily recognizes as a “coding loop.” As an oversimplified description, a coding loop can consist of the encoding part of an encoder (for example a source coder 403) (responsible for creating symbols based on an input picture to be coded, and a reference picture(s)), and a (local) decoder 406 embedded in the encoder 400 that reconstructs the symbols to create the sample data that a (remote) decoder also would create (as any compression between symbols and coded video bitstream is lossless in the video compression technologies considered in the disclosed subject matter). That reconstructed sample stream is input to the reference picture memory 405. As the decoding of a symbol stream leads to bit-exact results independent of decoder location (local or remote), the reference picture buffer content is also bit exact between local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is well known to a person skilled in the art.

The operation of the “local” decoder 406 can be the same as of a “remote” decoder 300, which has already been described in detail above in conjunction with FIG. 3. Briefly referring also to FIG. 4, however, as symbols are available and en/decoding of symbols to a coded video sequence by entropy coder 408 and parser 304 can be lossless, the entropy decoding parts of decoder 300, including channel 301, receiver 302, buffer 303, and parser 304 may not be fully implemented in local decoder 406.

An observation that can be made at this point is that any decoder technology except the parsing/entropy decoding that is present in a decoder also necessarily needs to be present, in substantially identical functional form, in a corresponding encoder. The description of encoder technologies can be abbreviated as they are the inverse of the comprehensively described decoder technologies. Only in certain areas a more detail description is required and provided below.

As part of its operation, the source coder 403 may perform motion compensated predictive coding, which codes an input frame predictively with reference to one or more previously-coded frames from the video sequence that were designated as “reference frames.” In this manner, the coding engine 407 codes differences between pixel blocks of an input frame and pixel blocks of reference frame(s) that may be selected as prediction reference(s) to the input frame.

The local video decoder 406 may decode coded video data of frames that may be designated as reference frames, based on symbols created by the source coder 403. Operations of the coding engine 407 may advantageously be lossy processes. When the coded video data may be decoded at a video decoder, the reconstructed video sequence typically may be a replica of the source video sequence with some errors. The local video decoder 406 replicates decoding processes that may be performed by the video decoder on reference frames and may cause reconstructed reference frames to be stored in the reference picture memory 405. which may be for example a cache. In this manner, the encoder 400 may store copies of reconstructed reference frames locally that have common content as the reconstructed reference frames that will be obtained by a far-end video decoder (absent transmission errors).

The predictor 404 may perform prediction searches for the coding engine 407. That is, for a new frame to be coded, the predictor 404 may search the reference picture memory 405 for sample data (as candidate reference pixel blocks) or certain metadata such as reference picture motion vectors, block shapes, and so on, that may serve as an appropriate prediction reference for the new pictures. The predictor 404 may operate on a sample block-by-pixel block basis to find appropriate prediction references. In some cases, as determined by search results obtained by the predictor 404, an input picture may have prediction references drawn from multiple reference pictures stored in the reference picture memory 405.

The controller 402 may manage coding operations of the video coder 403, including, for example, setting of parameters and subgroup parameters used for encoding the video data.

Output of all aforementioned functional units may be subjected to entropy coding in the entropy coder 408. The entropy coder translates the symbols as generated by the various functional units into a coded video sequence, by loss-less compressing the symbols according to technologies known to a person skilled in the art as, for example Huffman coding, variable length coding, arithmetic coding, and so forth.

The transmitter 409 may buffer the coded video sequence(s) as created by the entropy coder 408 to prepare it for transmission via a communication channel 411, which may be a hardware/software link to a storage device which would store the encoded video data. The transmitter 409 may merge coded video data from the video coder 403 with other data to be transmitted, for example, coded audio data and/or ancillary data streams.

The controller 402 may manage operation of the encoder 400. During coding, the controller 405 may assign to each coded picture a certain coded picture type, which may affect the coding techniques that may be applied to the respective picture. For example, pictures often may be assigned as one of the following frame types:

An Intra Picture (I picture) may be one that may be coded and decoded without using any other frame in the sequence as a source of prediction. Some video codecs allow for different types of Intra pictures, including, for example Independent Decoder Refresh Pictures. A person skilled in the art is aware of those variants of I pictures and their respective applications and features.

A Predictive picture (P picture) may be one that may be coded and decoded using intra prediction or inter prediction using at most one motion vector and reference index to predict the sample values of each block.

A Bi-directionally Predictive Picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4 x 4, 8 x 8, 4 x 8, or 16 x 16 samples each) and coded on a block-by-block basis. Blocks may be coded predictively with reference to other (already coded) blocks as determined by the coding assignment applied to the blocks’ respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

The video coder 400 may perform coding operations according to a predetermined video coding technology or standard, such as ITU-T Rec. H.265. In its operation, the video coder 400 may perform various compression operations, including predictive coding operations that exploit temporal and spatial redundancies in the input video sequence. The coded video data, therefore, may conform to a syntax specified by the video coding technology or standard being used.

In an embodiment, the transmitter 409 may transmit additional data with the encoded video. The source coder 403 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and so on.

According to embodiments herein, the processes both of encoding and of decoding may each be considered to be processing of visual media data performing a conversion between a visual media file and a bitstream of a visual media data according to a format rule.

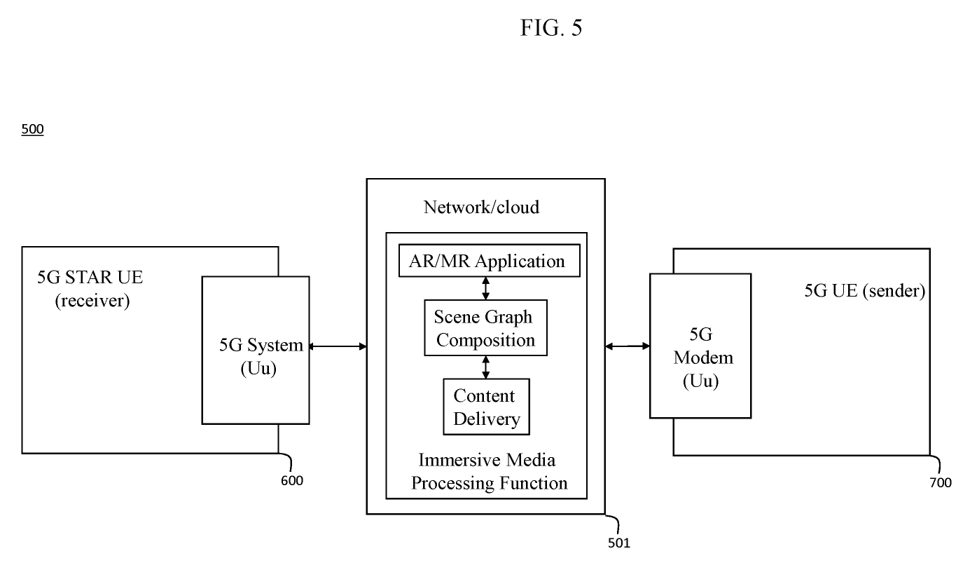

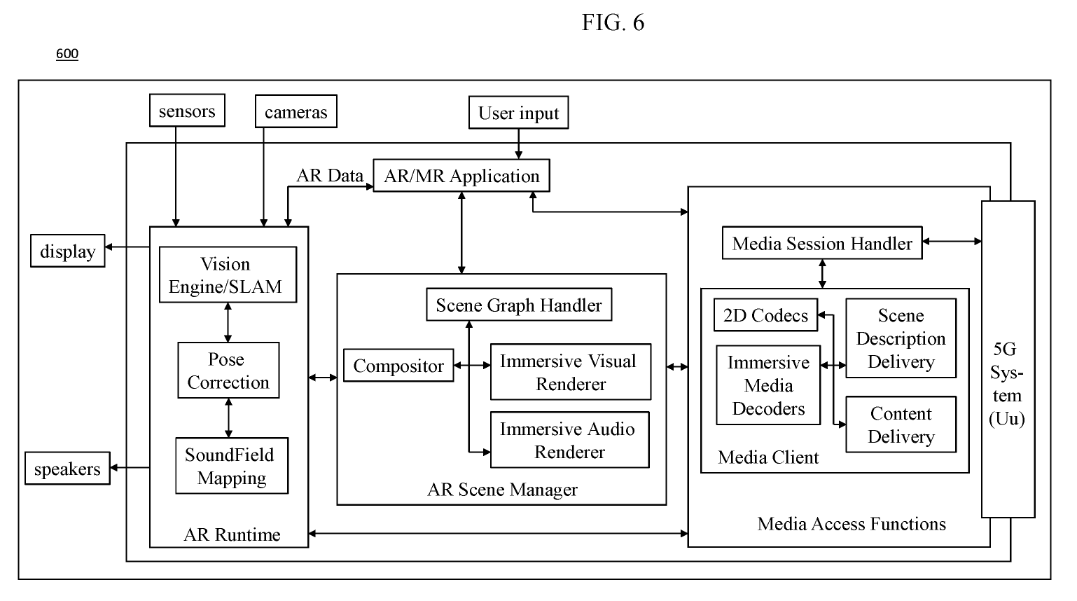

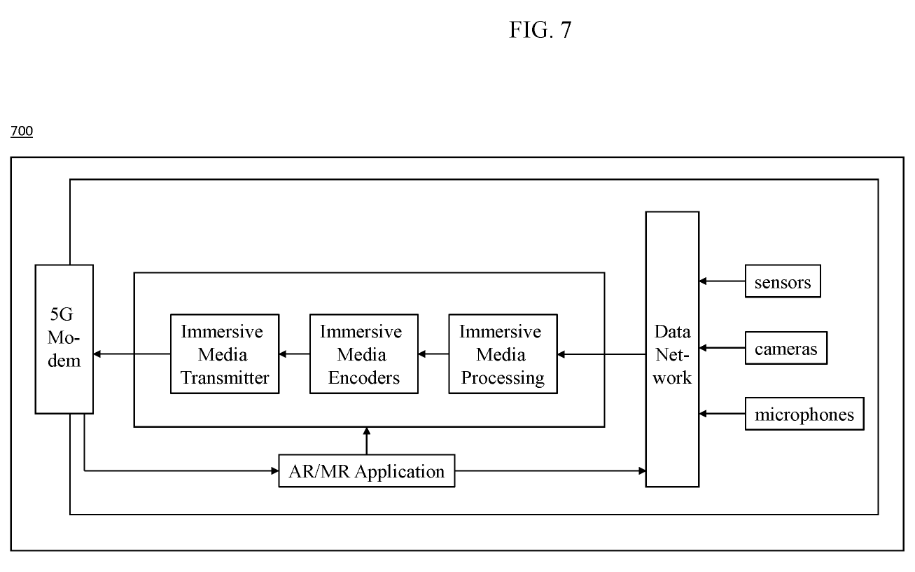

FIG. 5 is an example 500 of an end-to-end architecture for a stand-alone AR (STAR) device according to exemplary embodiments showing a 5G STAR user equipment (UE) receiver 600, a network/cloud 501, and a 5G UE (sender) 700. FIG. 6 is a further detailed example 600 of one or more configurations for the STAR UE receiver 600 according to exemplary embodiments, and FIG. 7 is a further detailed example 700 of one or more configurations for the 5G UE sender 700 according to exemplary embodiments. 3GPP TR 26.998 defines the support for glass-type augmented reality/mixed reality (AR/MR) devices in 5G networks. And according to exemplary embodiments herein, at least two device classes are considered: 1) devices that are fully capable of decoding and playing complex AR/MR content (Stand-alone AR or STAR), and 2) devices that have smaller computational resources and/or smaller physical size (and therefore battery), and are only capable of running such application if the large portion of computation is performed on 5G edge server, network or cloud rather than on the device (Edge dependent AR or EDGAR). Herein, acronyms Uu, Gnb, NEF, PCF, MSE, SDK, and 5GMSd may be considered to indicate User-to-User, gNodeB, physical control format, MExE (mobile execution environment) Service Environment, source deployment kit, and 5G maximum sensitivity degradation respectively. And M_d herein, such as M6d and M7d, regard UE MSH APIs that allow 5GMS-aware applications to interact with a 5GMSd MSH. RTP and AVP may be considered real time protocol and attribute value pairs respectively.

And according to exemplary embodiments, as described below, there may be experienced a shared conversational use case in which all participants of a shared AR conversational experience have AR devices, each participant sees other participants in an AR scene, where the participants are overlays in the local physical scene, the arrangement of the participants in the scene is consistent in all receiving devices, e.g., the people in each local space have the same position/seating arrangement relative to each other, and such virtual space creates the sense of being in the same space but the room varies from participant to participant since the room is the actual room or space each person is physically located.

For example according to the exemplary embodiments shown with respect to FIGS. 5-7, an immersive media processing function on the network/cloud 501 receives the uplink streams from various devices and composes a scene description defining the arrangement of individual participants in a single virtual conference room. The scene description as well as the encoded media streams are delivered to each receiving participant. A receiving participant’s 5G STAR UE 600 receives, decodes, and processes the 3D video and audio streams, and renders them using the received scene description and the information received from its AR Runtime, creating an AR scene of the virtual conference room with all other participants. While the virtual room for the participants is based on their own physical space, the seating/position arrangement of all other participants in the room is consistent with every other participant’s virtual room in this session.

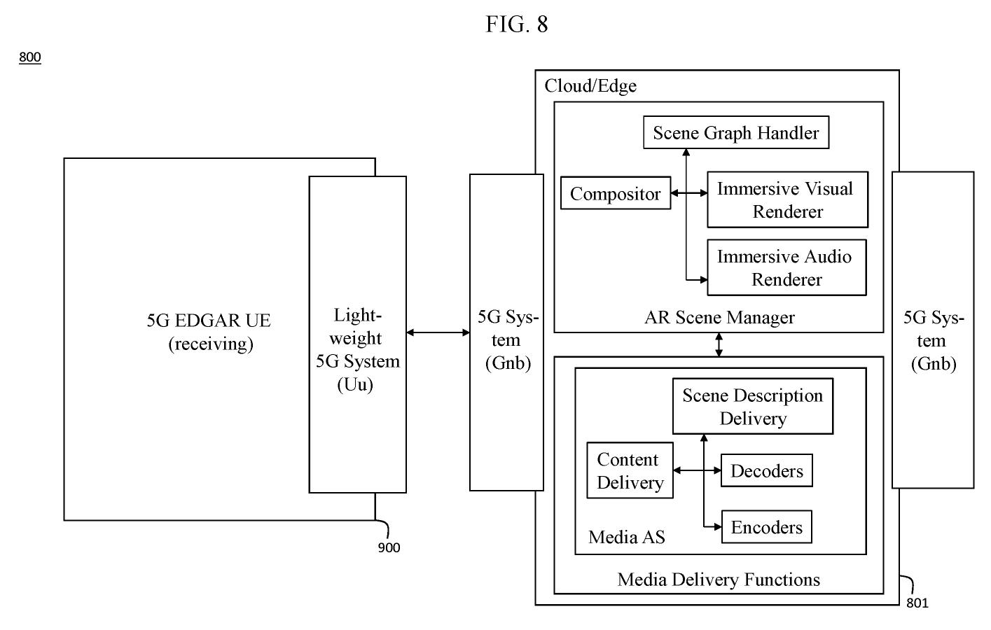

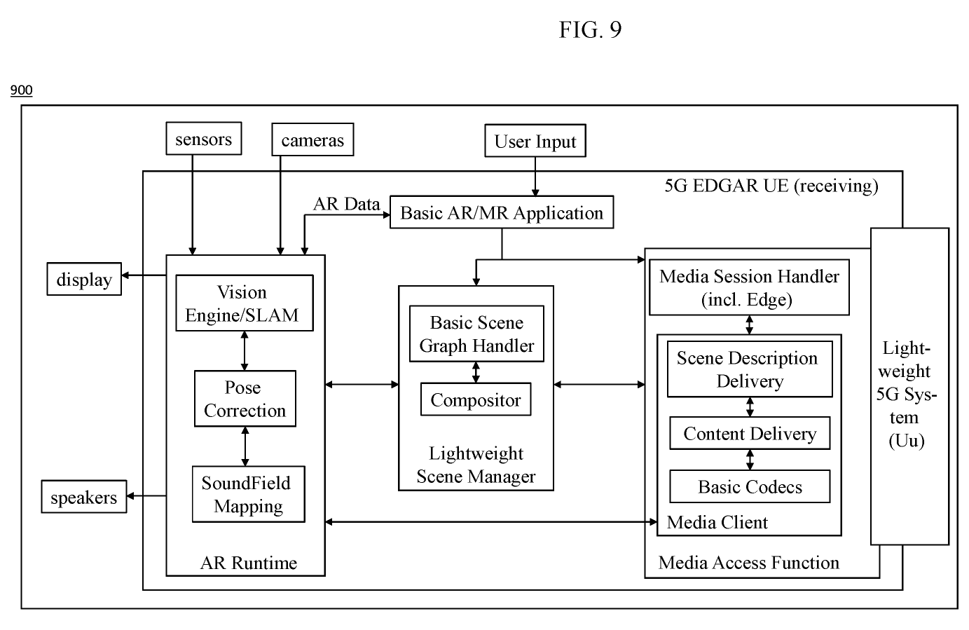

According to exemplary embodiments, see also FIG. 8 showing an example 800 regarding an EDGAR device architecture, where the device, such as the 5G EDGAR UE 900, itself is not capable of heavy processing. Therefore, the scene parsing and media parsing for the received content is performed in the cloud/edge 801, and then a simplified AR scene with a small number of media components is delivered to the device for processing and rendering. FIG. 9 shows a more detailed example of the 5G EDGAR UE 900 according to exemplary embodiments.

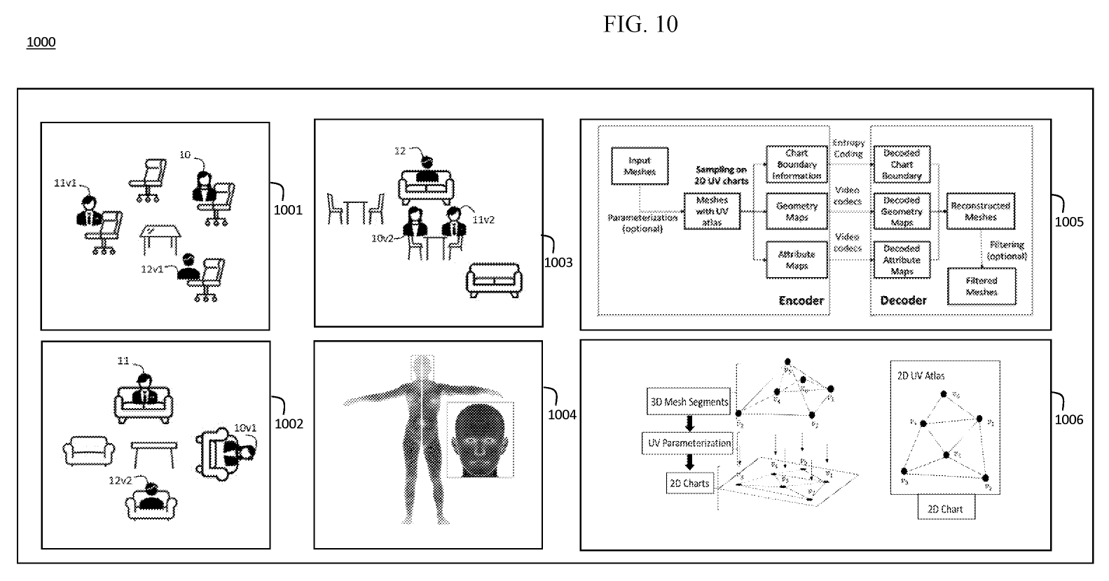

FIG. 10 shows an example 1000 in which user A 10, user B 11 and user T 12 are to participate in an AR conference room, and one or more of the users may not have an R device. As shown, user A 10 is in their office 1001, sitting in a conference room with various numbers of chairs, and user A 10 is taking on of the chairs. User B 11 is in their living room 1002, sitting on a love seat, there is also one or more couches for two people in his living room as well as other furniture such as a chair and table. User T 12 is at an airport lounge 1003, on a bench with a bench across a coffee table among one or more other coffee tables.

And see in the AR environment where in the office 1001, the AR of user A 10 shows to that user A 10 a virtual user B 11v1, corresponding to user B 11, and a virtual user T 12v1, corresponding to user T 12, and such that the virtual user B 11v1 and virtual user T 12v1 are shown to user A 10 as sitting on the furniture, office chairs, in the office 1001 as is the user A 10. And see in the living room 1202 in the example 1200 in which the AR for user B 11 shows the virtual user T 12v2, corresponding to the user T 12 but sitting on a couch in the living room 1202, and a virtual user A 10v1 corresponding to the user A 10 also sitting on furniture in the living room 1202 rather than the office chair in office 1201. See also in the airport lounge 1203 where the AR for the user T12 shows a virtual user A 10v2, corresponding to the user A 10 but sitting at a table at the airport lounge 1203, and a virtual user B 11v2 also sitting at the table across from virtual user A 10v2. And in each of those office 1201, living room 1202, and airport lounge 1203, the updated scene description of each room is consistent with other rooms in terms of position/seating arrangements. For example, user A 10 is shown as relatively counter-clockwise to user 11 or virtual representations thereof who is also relatively clockwise to user T 12 or virtual representations thereof per room.

But AR technology has been limited in any attempts to incorporate creation and use of virtual spaces for devices that do not support AR but can parse VR or 2D video, and embodiments herein provide for improved technological procedure for creating a virtual scene consistent with the AR scene when such devices participated in the shared AR conversational services.

The example 1004 represents an MPEG reference avatar body model. The MPEG-I Scene Description reference body avatar (FIG. 1) comes with its own mesh topology modeled as a female (right side) or as a male body (left side). The body base mesh is composed of three levels of detail (detailed in clause 6.2.1.1.2). As shown in FIG. 1, the density of vertex is not the same for the body and the face, because the later requires more accuracy for realism.

The example 1005 represents a framework of one dynamic mesh compression such as for a 2D atlas sampling based method. Each frame of the input meshes 701 can be preprocessed by a series of operations, e.g., tracking, remeshing, parameterization, voxelization. Note that, these operations can be encoder-only, meaning they might not be part of the decoding process and such possibility may be signaled in metadata by a flag such as indicating 0 for encoder only and 1 for other. After that, one can get the meshes with 2D UV atlases, where each vertex of the mesh has one or more associated UV coordinates on the 2D atlas. Then, the meshes can be converted to multiple maps, including the geometry maps and attribute maps, by sampling on the 2D atlas. Then these 2D maps can be coded by video/image codecs, such as HEVC, VVC, AV1, AVS3, etc. On the decoder side, the meshes can be reconstructed from the decoded 2D maps. Any post-processing and filtering can also be applied on the reconstructed meshes 704. Note that other metadata might be signaled to the decoder side for the purpose of 3D mesh reconstruction. Note that the chart boundary information, including the uv and xyz coordinates, of the boundary vertices can be predicted, quantized and entropy coded in the bitstream. The quantization step size can be configured in the encoder side to tradeoff between the quality and the bitrates. But such features are merely exemplary herein.

In some implementations, a 3D mesh can be partitioned into several segments (or patches/charts), one or more 3D mesh segments may be considered to be a “3D mesh” according to exemplary embodiments. Each segment is composed of a set of connected vertices associated with their geometry, attribute, and connectivity information. As illustrated in the example 1006 of volumetric data, the UV parameterization process of mapping from 3D mesh segments onto 2D charts, such as to the above noted 2D UV atlases block, maps one or more mesh segments onto a 2D chart in the 2D UV atlas. Each vertex (vn) in the mesh segment will be assigned with a 2D UV coordinates in the 2D UV atlas. Note that the vertices (vn) in a 2D chart form a connected component as their 3D counterpart. The geometry, attribute, and connectivity information of each vertex can be inherited from their 3D counterpart as well. For example, information may be indicated that vertex v4 connects directly to vertices v0, v5, v1, and v3, and similarly information of each of the other vertices may also be likewise indicated. Further, such 2D texture mesh would, according to exemplary embodiments, further indicate information, such as color information, in a patch-by-patch basis such as by patches of each triangle, e.g., v2, v5, v3 as one “patch”. But such features are merely exemplary herein.

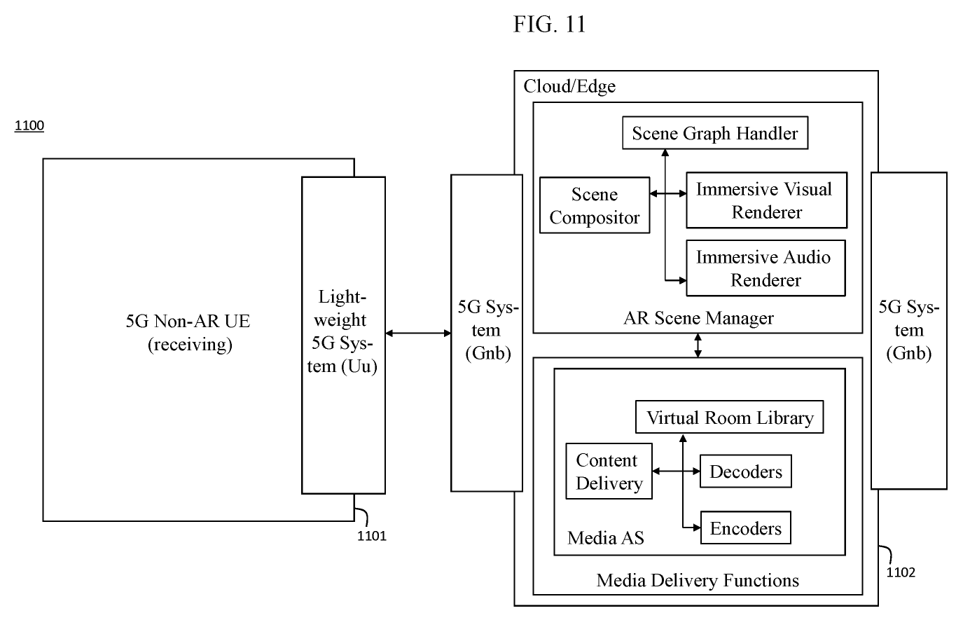

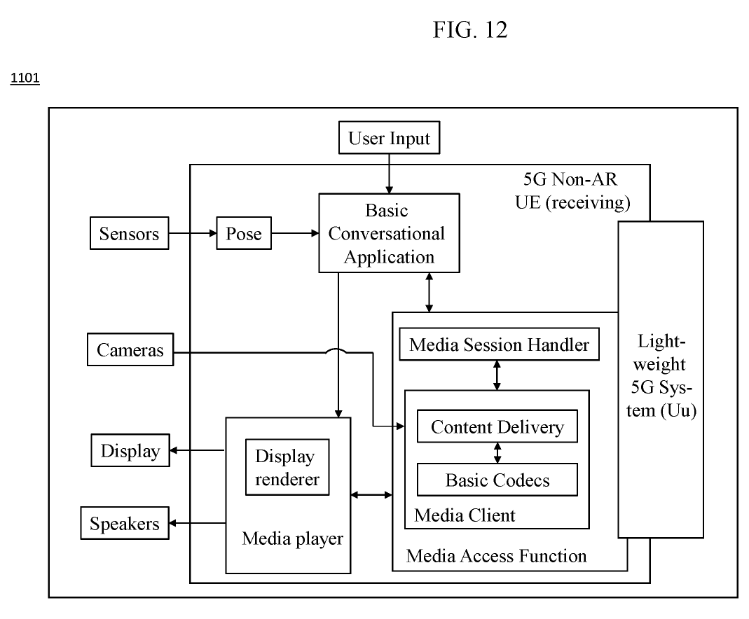

FIG. 11 shows an example 1100 of an end-to-end architecture with a non-AR device 1101 according to exemplary embodiments and a cloud/edge 1102. And FIG. 12 shows a further detailed block diagram example of the non-AR device 1101.

As is shown FIGS. 11 and 12, the non-AR UE 1101 is a device capable of rendering 360 video or 2-D video but does not have any AR capabilities. However, the edge function on the cloud/edge 1102 is capable of AR rendering of the received scene, rendering scene, and the immersive visual and audio object in a virtual room selected from the library. Then the entire video is encoded and delivered to the device 1101 for decoding and rendering.

As such, there may be multiview capabilities such as where AR processing on edge/cloud 1102 may generate multiple videos of the same virtual room: from different angles and with different viewports. And the device 1101 can receive one or more of these videos, switching between them when desired, or sends commands to the edge/cloud processing to only stream the desired viewport/angle.

Also, there may be changing the background capability, where the user on the device 1101 can select the desired room background from the provided library, e.g one of different conference rooms, or even living rooms and layouts. And the cloud/edge 1102 uses the selected background and creates the virtual room accordingly.

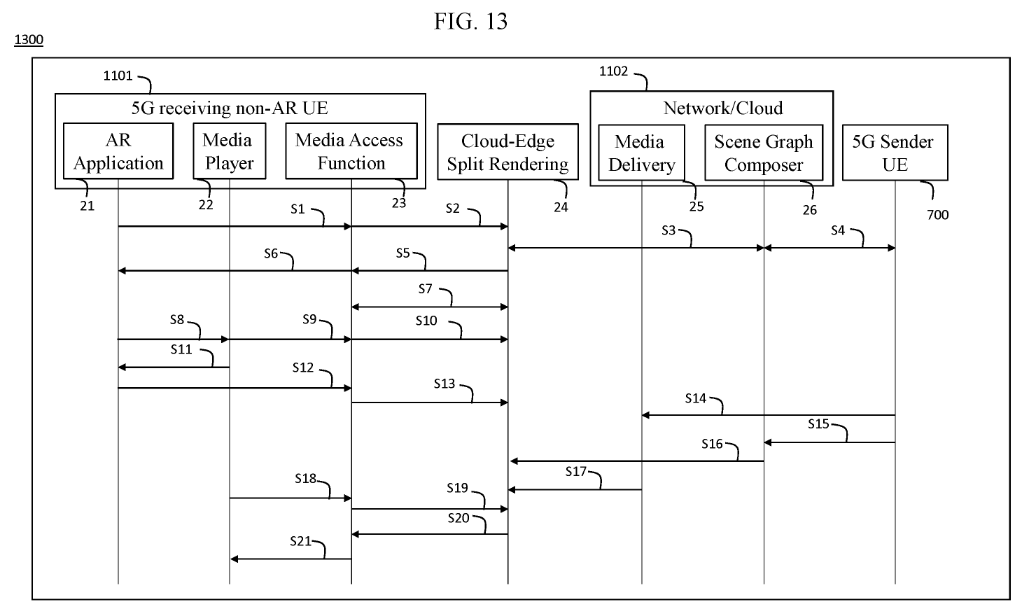

FIG. 13 illustrates an example timing diagram 1300 for an example call flow for an immersive AR conversational for a receiving non-AR UE 1101. For illustrative purposes, only one sender is shown in this diagram without showing its detailed call flow.

There is shown an AR application module 21, a media play module 22, and a media access function module 23 which may be considered to be modules of the receiving non-AR UE 1101. There is also shown a cloud/edge split rendering module 24. There is also shown a media delivery module 25 and a scene graph composer module 26 each of the network cloud 1102. There is also shown a 5G sender UE module 700.

S1-S6 may be considered a session establishment phase. The AR application module 21 may request to start a session to the media access function module 23 at S1, and the media access function module 23 may request to start a session to the cloud/edge split rendering module 24 at S2.

The cloud/edge split rendering module 24 may implement session negotiation at S3 with the scene graph composer module 26 which may accordingly negotiate with the 5G sender UE 700. If successful, then at S5, the cloud/edge split-rendering module may send an acknowledgement to the media access function module 23, and the media access function module 23 may send an acknowledgement to the AR application module 21.

Afterwards, the S7 may be considered to be a media pipeline configuration stage in which the media access function module 23 and the cloud/edge split-rendering module 24 each configure respective pipelines. And then, after that pipeline configuration, a session may be started by a signal at S8 from the AR application module to the media player module 22, and from the media player module 22 to the media access function module 23 at S9, and from the media access function module 23 to the cloud/edge split-rendering module 24 at S10.

Then there may be a pose loop stage from S11 to S13 in which at S11, pose data may be provided from the media player module 22 to the AR application module 21, and at S12, the AR application module may provide pose data 12 to the media access function module 23 after which the media access function module 23 may provide pose data to the cloud/edge split-rendering module 24.

S14 to S16 may be considered to be a shared experience stream stage in which at S14 the 5G sender UE 700 may provide media streams at S14 to the media delivery module 25 and AR data to the scene graph compositor module 26 at S15. Then the scene graph compositor module 25 may compose one or more scenes based on the received AR data and at S16 provide scene and scene updates to the could/edge split-rendering module 24, and also the media delivery module 25 may provide media streams to the cloud/edge split-rendering module at S17. This may include obtaining an AR scene descriptor from the non-AR device that does not render an AR scene and generating a virtual scene by a cloud device by parsing and rendering the scene description obtained from the non-AR device according to exemplary embodiments.

S18 to S19 may be considered to be a media uplink stage in which the media player module 22 captures and processes media data from its local user and provides, at S18, that media data to the media access function module 23. Then the media access module 23 may encode the media and provide, at S19, media streams to the cloud/edge split-rendering module 24.

Between S19 and S20 may be considered a media downlink stage in which the cloud/edge split-rendering module 24 may implement scene parsing and complete AR rendering after which, S20 and S21 may be considered to make up a media stream loop stage. At S20, the cloud/edge split-rendering module 24 may provide media streams to the media access function module 23 which may then decode the media and provide, at S21, media rendering to the media player 22.

By such features according to exemplary embodiments, the non-AR UE 1101, even though not having a see-through display and therefore not able to create an AR scene, nonetheless, can take advantage of its display that can render VR or 2-D video. As such, its immersive media processing function only generates a common scene description, describing the relative position of each participant to others and the scene. The scene itself needs to be adjusted with pose information at each device before being rendered as an AR scene as described above. And AR rendering process on edge or cloud can parse an AR scene and create the simplified VR-2D scene.

According to exemplary embodiments, this disclosure uses similar split-rendering processing of an EDGAR device for a non-AR device, such as a VR or 2-d video device, with characteristics such as the edge/cloud AR rendering process in this case does not produce any AR scene. Instead, it generated a virtual scene, by parsing and rendering the scene description received from the immersive media processing function for a given background (such as a conference room) and then renders each participant in the location described by the scene description in the conference room.

Also, the resulting video can be a 360 Video or a 2-D video depending on the capabilities of the receiving non-AR device, and the resulted video is generated considering the pos-information received from the non-AR device according to exemplary embodiments.

Also, each other participant with a non-AR device is added as a 2-D video overlay on the 360/2D video of the conference room, such as shown in FIG. 10, and the room may have regions that are dedicated to being used these overlays such as ones of the furniture where the virtual images are overlaid as shown in FIG. 10.

Also, the audio signals from all participants may be mixed if necessary to create single-channel audio that carries the voice in the room, the video may be encoded as a single 360 video or 2-D video and delivered to the device, and optionally, multiple video (multi-view) sources can be created, each of which captures the same virtual conference room from a different view and provide those views to the device according to exemplary embodiments.

Further, the non-AR UE device 1101 can receive the 360 video and/or one or more multi-view videos of choice along with audio and renders on the device display, and the user may switch between different views, or by moving or rotating the view device, change the viewport of the 360-video and therefore be able to navigate in the virtual room while viewing the video.

Although embodiments described above are provided with such 5G media stream architecture (5GMS) extensions to use the edge servers in their architectures, and while a specification thereof may have many features, such features have been technically unable to be deployed as a set of software development kits (SDKs) on a device or as a set of microservices on the cloud, and such technical deficiency is addressed by embodiments described further below.

For example, the current media service enabler technical report does not define a framework that relates the specification to SDKs and does not include any notion of microservices.

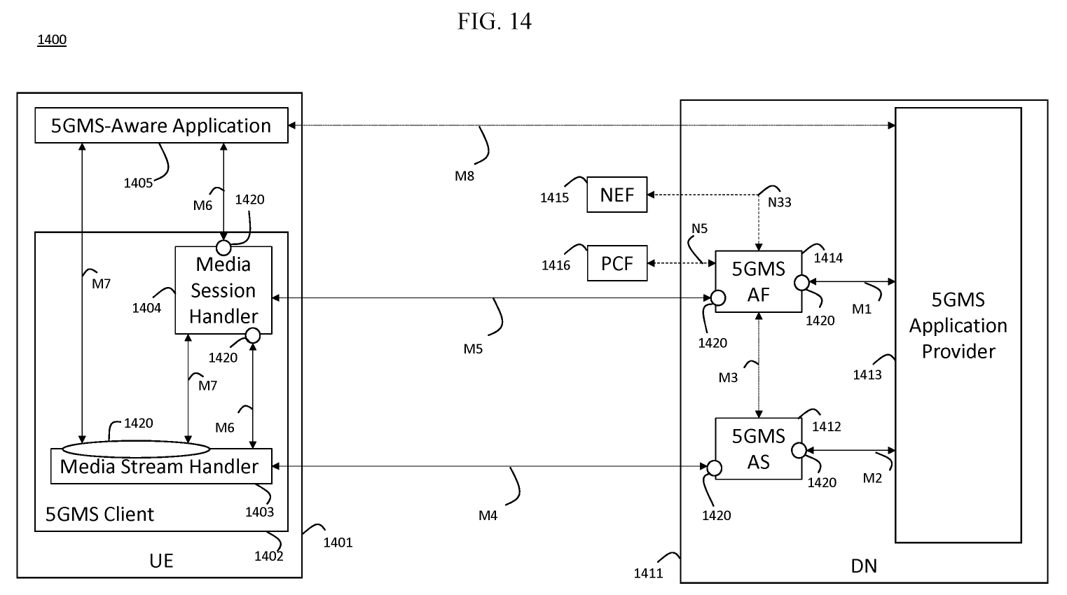

See the example 1400 of FIG. 14 showing a 5G media streaming architecture with edge extensions according to exemplary embodiments. As shown, there is a user equipment (UE) 1401 and a distribution network (DN) 1411. The UE 1401 may include a 5GMS client 1403 and a 5GMS-aware application 1405, such as the AR or non-AR embodiments described above those such applications are not limited thereto. The 5GMS client 1403 may also include a media stream handler 1403 and a media session handler. The DN 1411 may include a 5GMS application server (AS) 1412, a 5GMS application function (AF) 1414, and a 5GMS application provider 1413. The 5GMS AF 1414 may also be in communication with a network exposure function (NEF) 1415 and policy and charging function (PCF) 1416. Improvements described herein may be understood in the context of at least any one or more of the UE 1401, 5GMS aware application 1405, 5GMS application provider 1413, the NEF 1415 and the PCF 1416; that is, rather than having a monolithic specification that is absent definitions of the media service enabler (MSE) for each function or group of function, one or more of those elements may generate its own specification and, upon a conforming request provide such specification to another of those elements which may in turn further configure that initial elements specification depending on various possibilities such as those described further below, and such processing may be through any one or more of the shown multiple exposed application programming interfaces (APIs) 1420 and interfaces M1, M2, M4, M5, M6, M7, M8, N33, and N5.

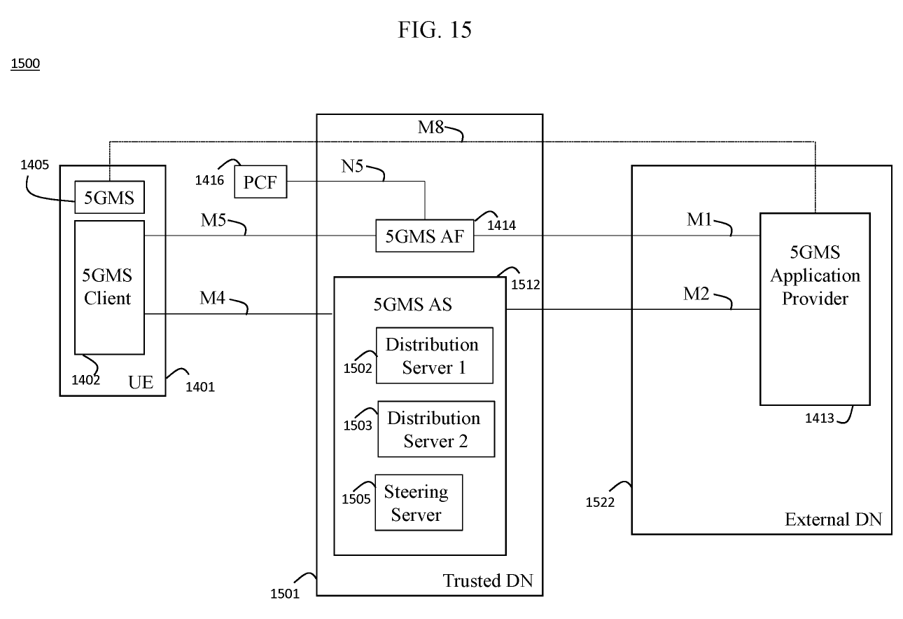

FIG. 15 shows an example 1500 in regards to content steering and distribution inside of a trusted Distribution Network (DN) or domain. Some components are shared in relation to FIG. 14, and FIG. 15 also illustrates a trusted DN 1501 with, of a 5GMS AS 1512, multiple distribution servers, such as “distribution server 1” 1502, “distribution server 2” 1503, and steering server 1505, along with an external DN 1502, which may have a 5GMS Application Provider 1413 like illustrated with FIG. 14.

In this collaboration scenario of FIG. 15, the content steering is provided by a mobile network operator between various distribution networks (internal CDNs). The content steering server 1505 also exists inside the trusted DN 1501.

And according to exemplary embodiments in view of FIG. 15, (1) the mobile network operator (MNO), which can be considered as having the trusted DN 1501, provides multiple distribution servers, such as “distribution server 1” 1502 and “distribution server 2” 1503 in the trusted DN 1501, to deliver the content to/from the UE 1401. (2) The MNO also provides a content steering server 1505 in the trusted DN 1501. The published manifest by the Application Service Provider, such as the 5GMS Application provider 1413, does not have the content steering information. The MNO manipulates the manifest by adding BaseURLs as well as the steering server information before providing it to the client, such as at the UE 1401. (4) During streaming, the UE 1401 makes requests to the content steering server based on the information provided, and the content steering operation is internal to MNO and opaque to the Application Provider 1413 of the external DN 1522 according to exemplary embodiments.

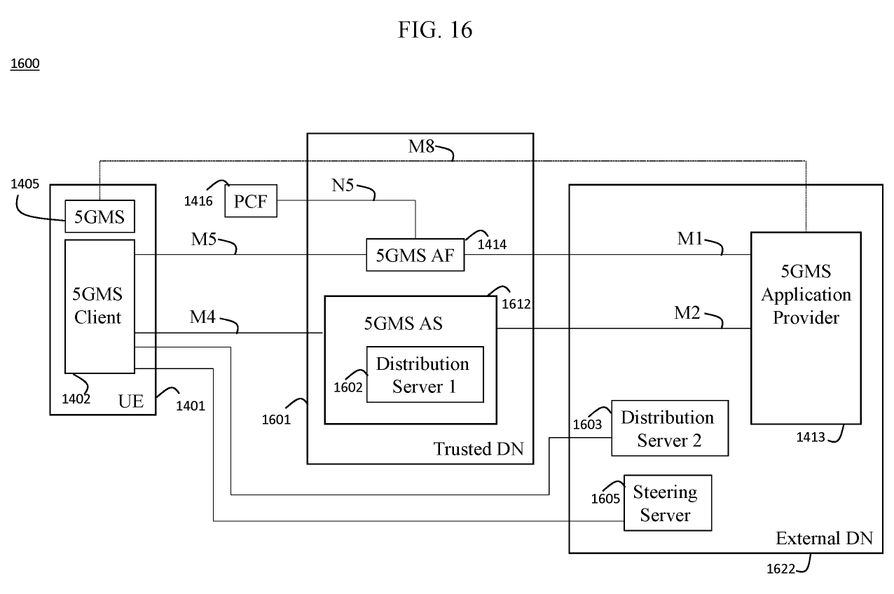

FIG. 16 illustrates an example 1600 of content steering and some distributions outside of the trusted DN. For example, compared to FIG. 15, there may be a trusted DN 1601 in which a 5GMS AS 1612 may have at least one distribution server, such as “distribution server 1” 1602, and other servers, such as “distribution server 2” 1603 and steering server 1605 may be provided in the external DN 1622. In this collaboration, the content steering is provided by an outside entity in the external DN 1622 steers the UE 1401 to get the content among multiple delivery networks, one of which is the MNO network, having the trusted DN 1601.

And according to exemplary embodiments in view of FIG. 16, (1) the MNO may provide one of the distribution networks, the “distribution server 1” 1602, for delivering the content to/from the UE 1401. The content may be delivered by other distribution networks, , such as “distribution server 2” 1603, outside of the MNO’s trusted DN 1601. The Application Provider 1413 has the information of the external distribution networks 1622. The existence and nature of these networks are not necessarily known to MNO according to exemplary embodiments. (2) The content steering server 1605 is also located in the external DN 1622. (3) The Application Provider 1413 provides a manifest that contains BaseURLs for the MNO’s distribution network as well as the external distribution networks and also information regarding content steering service. (4) The client may use the MNO’s distribution network, 1601, or an external network 1622 depending on the content steering server’s 1605 responses.

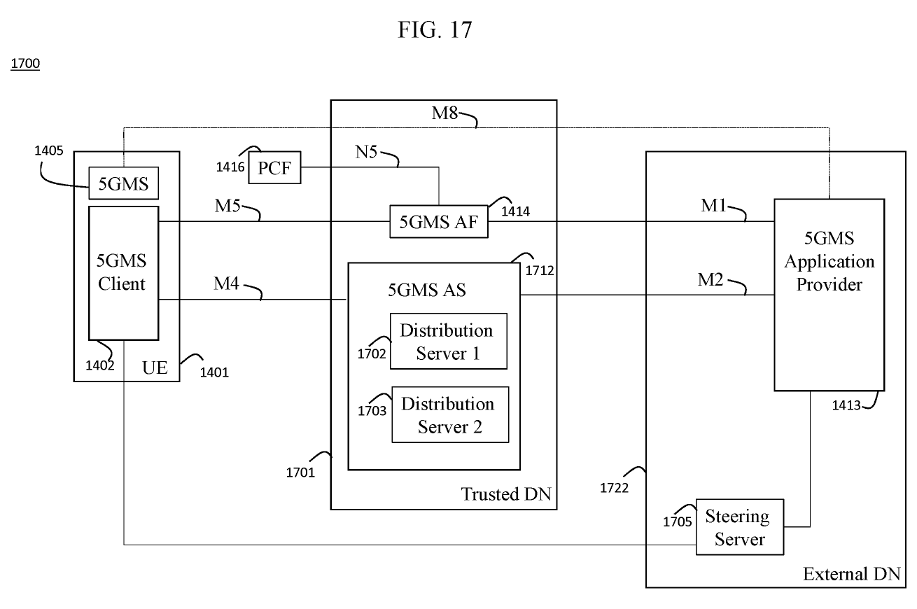

FIG. 17 illustrates an example 1700 for content steering outside of, while distribution inside of a trusted DN, may be implemented. For example, compared to FIG. 15, there may be a trusted DN 1701 in which a 5GMS AS 1712 may have at least two distribution servers, such as “distribution server 1” 1702 and “distribution server 2” 1703, and the steering server 1705 may be provided in the external DN 1722. In this collaboration, the content steering is provided by an outside entity in the external DN 1722 steers the UE 1401 to get the content among multiple delivery networks, one of which is the MNO network, having the trusted DN 1701.

And according to exemplary embodiments in view of FIG. 17, (1) the MNO provides all distribution networks, such as “distribution server 1” 1702 and “distribution server 1” 1702 of the trusted DN 1701 of the MNO, for delivering the content to/from the UE 1401. (2) The Application Provider 1413 has the information on the MNO distribution networks. (3)

The content steering server is located in the external DN 1722. (4) The Application Provider 1413 provides a manifest that contains BaseURLs for the MNO’s distribution networks as well as the information regarding content steering service. (5) The client, the client 1402 of the UE 1401, may use the MNO’s distribution networks depending on the content steering server’s 1705 responses.

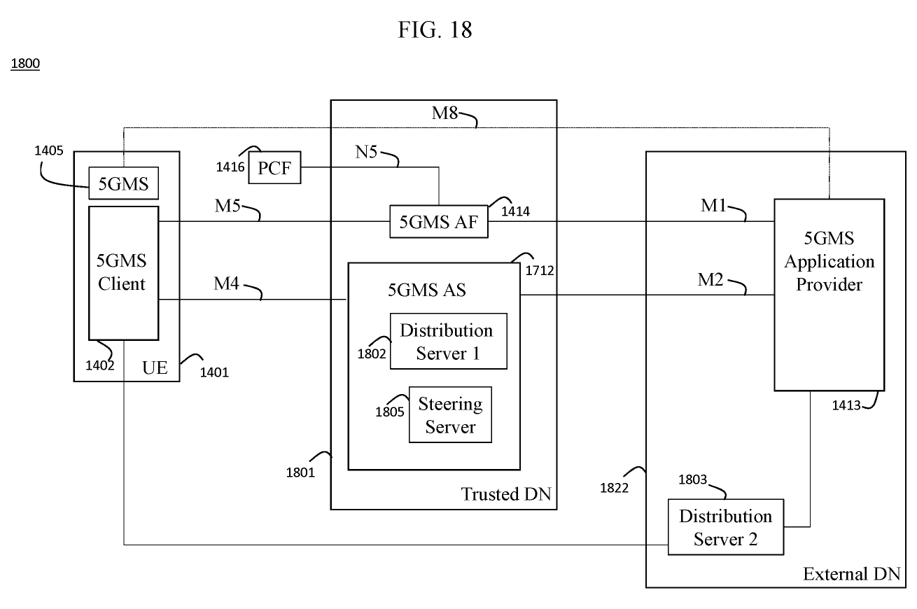

FIG. 18 illustrates an example 1800 for content steering inside, while distribution inside and outside of a trusted DN, may be implemented. For example, compared to FIG. 15, there may be a trusted DN 1801 in which a 5GMS AS 1812 may have a distribution server, such as “distribution server 1” 1802, and the steering server 1805. The “distribution server 2” 1803 may be provided in the external DN 1822. In this collaboration, some distribution networks are outside of the MNO; however, the content steering is provided by the MNO.

And according to exemplary embodiments in view of FIG. 18, (1) the MNO provides some distribution networks, such as “distribution server 1” 1802, for delivering the content to/from the UE 1401 as well as the content steering by steering server 1805. (2) The Application Provider 1413 also provides information about the external distribution networks to the MNO. (3) The MNO, such as by the trusted DN 1801, manipulates the manifest to add the BaseURLs for the MNO’s distribution networks as well as the information regarding content steering service. (4) The client, the client 1402 of the UE 1401, may use the MNO’s distribution networks, such as “distribution server 1” 1802, or outside distribution, such as “distribution server 2” 1803 depending on the content steering server’s 1805 responses. However, the content steering is run by MNO.

As such, there are provided several methods of deployment of content steering services in 5G media delivery, wherein the distribution servers may be located inside or outside of the mobile network operator, and/or the content steering server may be located inside or outside of the mobile network operator, wherein in each case, the process of generation/manipulation of the manifest is described, as well as the operational point wherein the client uses the content steering information to select and stream to or from a distribution network, wherein depending on where the distribution networks are located and where the content steering server is located, various flow of information is needed to effectively deploy content steering services.

In terms of common server- and network-assisted streaming, embodiments herein provide for common server- and network-assisted streaming scenarios that leverage content steering mechanisms for efficient content delivery. These scenarios address both internal and external collaboration models, emphasizing optimized delivery paths, latency reduction, and bandwidth efficiency. The references include ETSI TS 103 998 [ETSI-CS] for content steering in DASH environments, ensuring alignment with industry standards.

As similarly described with respect to the example 1500, there is provided content steering, content steering and distribution inside the trusted domain, by the Mobile Network Operator between various distributions provided by the 5GMSd AS. The content steering server also exists inside the trusted DN. And in such embodiments, (1) the MNO provides multiple 5GMSd AS instances to deliver the content to/from the UE at reference point M4d. (2) The MNO also provides a content steering server as part of the 5GMSd AS. (3) The presentation manifest published by the 5GMSd Application Provider at reference point M2d does not include any content steering information. The 5GMS System manipulates the manifest by adding Base URLs, as well as the steering server information, before providing it the 5GMSd Client at reference point M2d. And (4) During streaming, the UE makes requests to the content steering server based on the information provided. The content steering operation is internal to the MNO’s 5GMS System and opaque to the 5GMSd Application Provider.

As similarly described with respect to the example 1600, content steering, such as content steering outside the trusted domain with mixed content delivery inside and outside, is provided by an outside entity in the external DN which steers the UE to get the content among multiple delivery networks, one of which is the MNO’s 5G System. And in such embodiments (1) The MNO provides a 5GMSd AS for delivering the content to/from the UE. The same content is also available from other distribution networks outside the MNO’s trusted DN. The 5GMSd Application Provider has the information of the external distribution networks. The existence and nature of these networks are not necessarily known to the MNO. (2) The content steering server is also located in the external DN. (3) The 5GMSd Application Provider provides a presentation manifest at reference point M2d that contains Base URLs for the MNO’s 5GMSd AS as well as the external distribution networks and also information regarding the content steering service. (4) The 5GMSd Client may use the MNO’s 5GMSd AS at reference point M4d, or an external network depending on the content steering server’s responses.

As similarly described with respect to the example 1700, there is provided content steering, such as content steering outside and content delivery inside trusted domain, provided by an outside entity in the external DN steers the UE to retrieve content from multiple 5GMSd AS instances, all of which are deployed in the Trusted DN of the MNO. And in such embodiments, (1) The MNO provides 5GMSd AS instances for delivering the content to/from the UE. (2) The 5GMSd Application Provider has the information about the MNO 5GMSd AS instances. (3) The content steering server is located in the external DN. (4) The Application Provider provides a presentation manifest at reference point M2d that contains Base URLs for the MNO’s 5GMSd AS instances, as well as the information regarding the external content steering service. (5) The 5GMSd Client uses one of the MNO’s 5GMSd AS instances at reference point M4d depending on the content steering server’s responses.

As similarly described with respect to example 1800, there is provided content steering, such as content steering inside and content delivery insider and outside of the trusted domain, is provided by the MNO. But at least one of distribution networks exists outside of the trusted DN. And in such embodiments, (1) the MNO provides some of 5GMSd AS instances for delivering the content to/from the UE. (2) The 5GMSd Application Provider has the information of the MNO 5GMSd AS instances. (3) The content steering server is provided by MNO. (4) The Application Provider provides a presentation manifest at reference point M2d that contains Base URLs for the MNO’s 5GMSd AS instances as well as the external content servers’ Base URLs. (5) The 5GMSd Client selects one of the content servers at reference point M4d or the external content server(s) depending on the content steering server’s responses.

According to exemplary embodiments, the interfaces M1, M2, M4, M5, and M8 of FIGS. 15-18 may also be considered as M1d, M2d, M4d, M5d, and M8d interfaces.

As such, there is provided embodiments of mapping to existing 5G frameworks with enhancements to support content steering across different scenarios such as trusted domain only: Within the MNO's trusted domain, the architecture includes multiple 5GMSd AS service locations/endpoints interconnected via reference points M4d and M8d. The content steering server dynamically assigns delivery paths. Steering is accomplished by having the DASH client periodically access a content steering server to retrieve a steering manifest, which instructs the player as to the availability and priority of the service locations/endpoints.

There is provided embodiments of mapping to existing 5G frameworks with enhancements to support content steering across different scenarios such as Hybrid trusted and external domains: For scenarios where delivery spans both trusted and external domains, the 5GMSd Client interacts with the steering server via interfaces outside the scope of 3GPP. Inter-domain metadata exchange ensures proper selection between trusted 5GMSd AS endpoints/locations and external CDNs based on factors such as load balancing, geolocation, and service-level agreements.

And in terms of a high-level call flow, embodiments herein provide

high-level call flow involving multiple stages:

Content discovery and manifest retrieval: The 5GMSd Application Provider publishes a presentation manifest at M2d, which is augmented by the MNO to include steering metadata (e.g., base URLs, steering logic).

Steering decision and content request: The 5GMSd Client queries the steering server (via reference point M24d) for an optimal delivery path. The decision incorporates real-time factors, such as network congestion, content cache location, and user QoS profiles.

Content delivery: Based on the steering server's response, the 5GMSd Client retrieves content from the selected 5GMSd AS endpoint/location (reference point M4d) or external CDN.

Adaptation and monitoring: The delivery adapts dynamically to changing conditions, ensuring uninterrupted playback and meeting the KPIs for latency and throughput.

The collaboration scenarios provided herein are intended to address the challenges of integrating server- and network-assisted streaming in hybrid environments, leveraging content steering to optimize delivery paths across trusted and external networks. The Key Issue on media delivery from multiple service endpoints/locations in clause 5.19 of 3GPP TR 26.804 18.2.0 addresses the majority of considerations to add Content Steering to 5G Media Streaming.

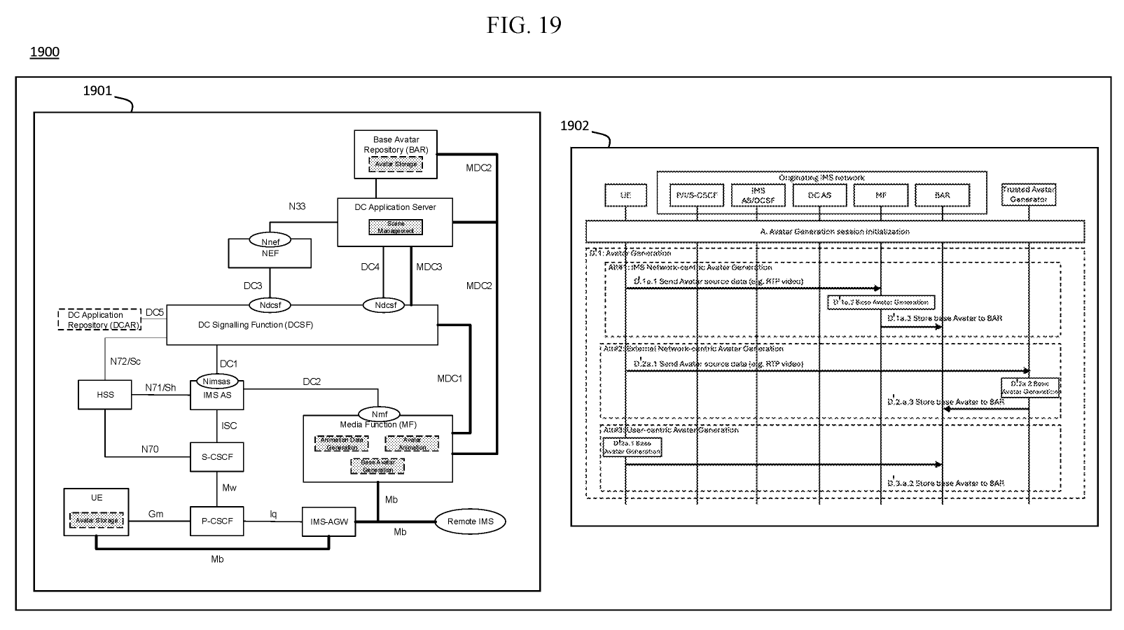

Annex AC.11 of TS 23.228 describes the IMS DC architecture for avatar communication. And as a supplement 1900 according to embodiments herein, FIG. 19 shows an example 1901 mapping of avatar functions which are defined in clause 7 to the IMS DC architecture, specifically the possible avatar functions which may be supported by the media function (MF).

Note that the Animation Data Generation, Avatar Animation, and Base Avatar Generation functions may also be part of the user equipment (UE).

The generation of a Base Avatar by the Base Avatar Generation function may happen in either the UE or the media function (MF), but Base Avatars may also already be available in the Avatar Storage function either in the UE or the Base Avatar Repository (BAR). Base Avatars generated by the UE or the MF may be stored into the UE or the BAR.

Depending on the possible configurations, as shown in clause 7, a specific avatar workflow is decided through the negotiation between the UE and the network, ultimately deciding on the need for certain avatar functions in each entity.

The following descriptions are the supplements and refinements based on Annex AC.11 of TS 23.228: BAR (Base Avatar Repository): -Avatar Storage: Stores the Base Avatar Representations and their associated Avatar IDs. NOTE1: One or more Base Avatars may be stored for a user, and each Base Avatar is identified with an Avatar ID. MF: -Base Avatar Generation: the MF may generate base avatar from the user input and store the base avatar to BAR. For 3D avatars, the base avatar may be a 3D model or an INR model. For 2D avatars, the base avatar is comprised of a DNN model and a base image/video. The base avatar generation may be a transcoding process between two avatar representation formats. - Animation Data Generation: the MF generates animation data using conventional or AI/ML technologies based on the media received from the user. The animation data generation may be a transcoding process between two animation formats associated to avatar representation formats. -Avatar Animation: the MF generates or downloads the base avatar, and animates the base avatar using the received animation data. NOTE2: During an IMS based avatar communication, the MF may temporarily store relevant Base Avatars in a cache for provision to participating UEs. DC application server (AS): -Scene Management: supports the scene description document management. For 2D avatar, the scene description is not needed. Through such functions, the network may assist the UE with media processing related to the creation of avatar and animation data, as well as the consumption of avatar data, in particular scene management/composition and rendering. For the support of avatar services based on the IMS DC architecture, media negotiation between the UE and the network should include aspects related to: UE capability, Network capability. The following media interface are used for the IMS-based avatar communication services. -MDC2: Reference point of Avatar representation downloading between MF and BAR.

This innovation extends the capabilities of the MF to support transcoding the Avatar Base representation format and its associated animation controls into a format understood by the other user devices, or into a mezzanine format (and animation controls) for which there is a fully defined interoperability point.

This invention uses the Media Function (MF) in the Nmf (a service-based interface exhibited by MF) of the IMS architecture to transcode Avatar formats into a format supported by at least one end user, or into a mezzanine format that has interoperability points fully defined.

This invention also uses the Media Function (MF) in the Nmf of the IMS architecture to transcode Avatar animation data into a format supported by at least one end user, or into a mezzanine format that has interoperability points fully defined.

As such, there is provided a method for transcoding an avatar base representation format in the Media function of the Nmf of an IMS architecture, into a format that is supported by at least one UE (user equipment).

And there is also provided there is provided a method for transcoding an avatar animation controls in the Media function of the Nmf of an IMS architecture, into a format that is supported by at least one UE (user equipment).

And there is also provided a method for transcoding an avatar base representation format and its animation controls in the Media function of the Nmf of an IMS architecture, into a mezzanine format that that interoperability points defined by the service specification.

And there is also provided a method for transcoding an avatar base representation format and its animation controls in the Media function of the Nmf of an IMS architecture, into a mezzanine format that that interoperability points defined by the service specification.

Further, example 1902 shows that prior to a call session, an Avatar generation session may be required to ensure the availability of the requested Avatar in the BAR. This may include the generation of an Avatar in multiple formats as required by the end devices capabilities. According to embodiments herein, the generation of the base avatar representation may happen in different entities depending on the device capabilities (in the UE), the service functionalities offered by the IMS network (in the MF or the BAR), or the availability of a dedicated function under the MNO trusted environment.

According to one or more IMS network-centric avatar generation embodiments herein, at D’.1a.1: UE sends captured data needed to generate the base avatar to the MF. At D’.1a.2: The MF uses the captured data sent by UE to generate the base avatar for the user. And at D’.1a.3: MF may store the generated base avatar to MF for future loading.

According to one or more external network-centric avatar generation embodiments herein, at D’.2a.1: UE sends captured data needed to generate the base avatar to an Avatar Generator in the MNO trusted domain. NOTE: The communication between the UE and the external Avatar generator is out of scope of this study. At D’.2a.2: The Avatar Generator uses the captured data sent by UE to generate the base avatar for the user. And at D’.2a.3: MF may store the generated base avatar to MF for future loading.

According to one or more UE-centric avatar generation embodiments herein, at D’.3a.1: UE uses the captured data needed to generate the base avatar and generates locally the base avatar for the user. And at D’.3a.2: MF may store the generated base avatar to MF for future loading.

Example features for a call setup and capability negotiation according to embodiments herein may regard features such that the parameters of the session are negotiated if UE centric mode or network centric mode is needed. This includes exchanging capability information, media and metadata descriptions and formats. The involved entities agree on assignment of avatar generation, animation tasks and media requirements.

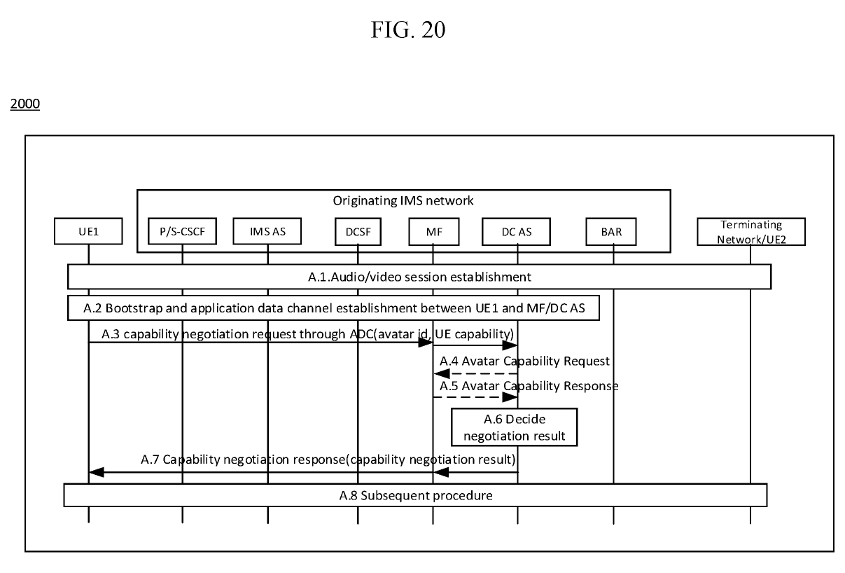

FIG. 20 shows an example 2000 regarding network centric call setup and capability negotiation flow features according to embodiments herein. For network centric mode, the capability negotiation procedure is based on the avatar type (2D or 3D) and the capability information of UE and MF. The capability information includes the animation data type(s) (e.g., text, expression data and motion signals for joints) supported by UE or MF. After capability negotiation, the IMS AS instructs MF to download UE1’s base avatar from BAR, generate animation data by the source data received from UE1, and animate UE1’s base avatar by the animation data received from UE1 or generated by MF itself.

At A.1, an audio/video session is established between UE1 and UE2. At A.2, the bootstrap and application data channels are established between UE1 and IMS. At A.3, the UE1 sends a capability negotiation request using the application data channel through MF to the DC AS. The message carries parameters including an avatar id chosen by UE1 and animation data types (e.g., text, expression data and motion signals for joints) supported by UE1. At A.4, The DC AS sends an avatar capability request to MF. At A.5, the MF responses its avatar capability information to the DC AS. NOTE1: The step A.4 and A.5 are optional. The DC AS can decide MF’s avatar capability based on its local configuration. NOTE2: The service of avatar capability provided by MF will be further defined in CT1/CT4 if needed. At A.6, the DC AS gets the avatar type (2D or 3D, from base avatar retrieved from BAR or to be generated by the MF) by avatar id, and confirms the capability negotiation result based on the avatar type and the capability supported by UE1 and MF. The capability negotiation result includes the animation method (e.g., by audio, text or expression data and motion signals for joints). At A.7, the DC AS sends the capability negotiation response to UE1 through MF. The message carries the capability negotiation result. And at A.8, the subsequent procedure continues. And such features represent an example of network centric call setup and capability negotiation flow features according to embodiments herein.

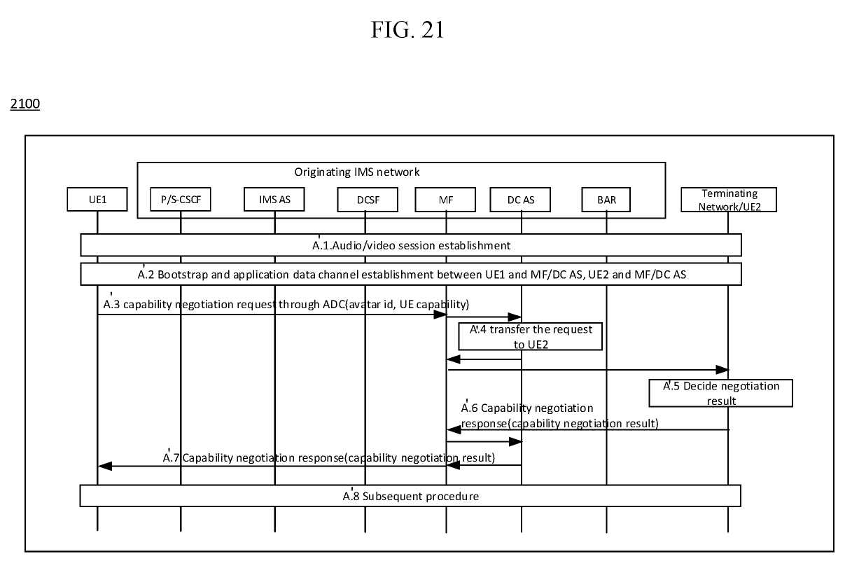

FIG. 21 shows an example 2100 regarding UE centric call setup and capability negotiation flow. For example, for UE centric mode features according to embodiments herein, if UE1 centric procedure is used, there is no capability negotiation initialized by UE1, so only UE2 centric call flow is introduced. In UE2 centric procedure, the base avatar of UE1 is sent from MF to UE2 using data channel, and the animation data is sent from UE1 or MF to UE2 using real-time transport protocol (RTP) or data channel.

According to embodiments herein, at A’.1, an audio/video session is established between UE1 and UE2. At A’.2, the bootstrap and application data channels are established between UE1 and IMS, UE2 and IMS. At A’.3, the UE1 sends a capability negotiation request using the application data channel through MF to the DC AS. The message carries an avatar id chosen by UE1 and the animation data types supported by UE1. At A’.4, the DC AS check if UE2 centric mode is used, then the DC AS transfers the capability negotiation request to UE2 through MF. The request carries the animation data types supported by MF in addition to the capability negotiation parameters. At A’.5, the terminating network/UE2 finishes the capability negotiation. At A’.6, the terminating network/UE2 returns the capability negotiation response carrying the negotiation result. The negotiation result includes the animation method (e.g., by audio, text or expression data and motion signals for joints). At A’.7, the DC AS transfers the capability negotiation response to UE1 through MF. And at A’.8, the subsequent procedure continues. And such features represent an example of UE centric call setup and capability negotiation flow features according to embodiments herein.

Examples 2200 and 2300 show examples of avatar delivery and animation according to embodiments herein in which, at A, there is call setup and capability negotiation by which an audio/video session is established between UE1 and UE2 and parameters of the session are negotiated. At B, there is scene description retrieval by which the MF and the participating UEs retrieve scene descriptions, the scene description may be shared by the MF with the UEs, or the UEs may have their own scene descriptions. And at C. Scene Description Update.

A scene update trigger occurs, e.g., if an object is added to or removed from a scene or if spatial information is updated. The update trigger may originate from the MF itself or the UEs. The UEs may update their scene descriptions independently or the MF may generate an updated scene description and share it with the UEs. NOTE1: The step B and C are not needed for 2D avatar according to example embodiments.

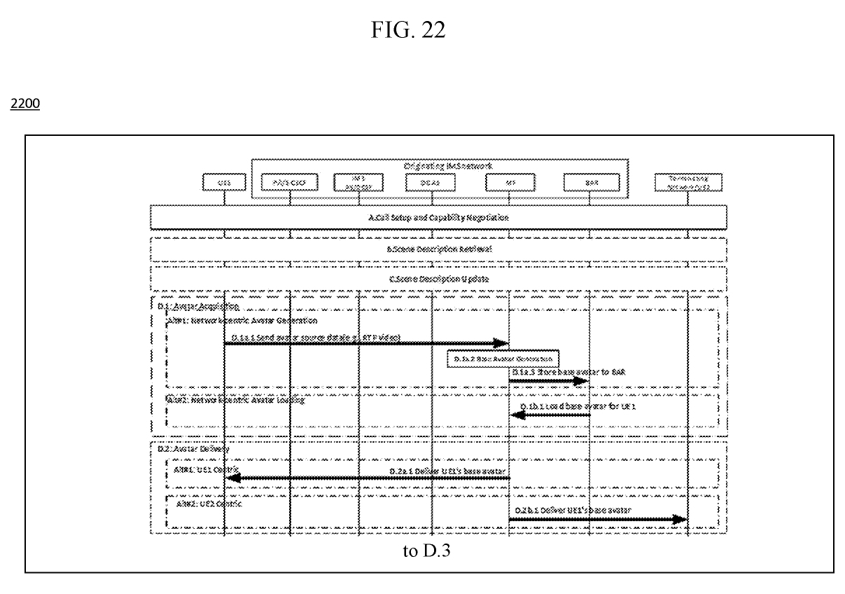

At D.1., as in FIG. 22, there is avatar acquisition, and as an Alternative #1 thereof, by Network-centric Avatar Generation, at D.1a.1, theUE1 sends captured data needed to generate the base avatar to the MF. And at D.1a.2, the MF uses the captured data sent by UE1 to generate the base avatar for the user, and at D.1a.3, the MF may store the generated base avatar to MF for future loading. NOTE2: This network-centric avatar generation may occur before avatar communication starts. And as Alternative #2 thereof, with Network-centric Avatar Loading, at D.1b.1, The MF loads the base avatar (for 2D avatar, the base avatar is comprised of a DNN model and a base image/video; for 3D avatar, the base avatar can be a 3D model or an INR model) for UE1 from BAR.

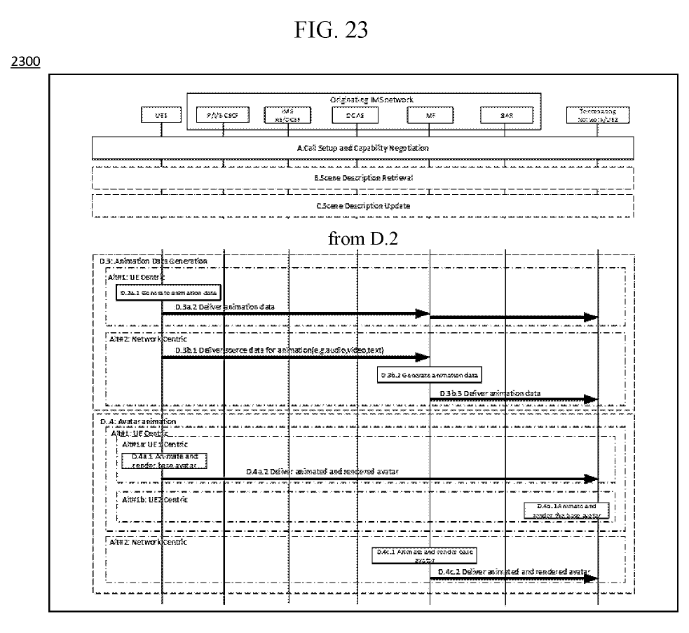

At D.2., as in FIG. 22, for avatar delivery, and as an Alternative #1 thereof, by UE1 centric features of embodiments herein, at D.2a.1, the MF delivers the base avatar to UE1 through data channel. And as Alternative #2 thereof, by UE2 centric features, at D.2b.1, the MF delivers the base avatar to UE2 through data channel. As a note, the “to D.3” in FIG. 22 implies that the FIGS. 22 and 23 may be understood as connected such that the D.3 features of FIG. 23 are under the D.2 features of FIG. 22.

And so, as in the example 2300 shown in FIG. 23, there is D.3 Animation Data Generation features of which, based on the capability negotiation result in step A, the UE or network may generate animation data. As such, as an Alternative #1 thereof, by UE centric animation data generation features of embodiments herein, at D.3a.1, the UE1 generates the animation data based on the source data (e.g., audio, video, text). The animation data may be transformed from the source data (e.g., from audio to text), or the same as the source data. And at D.3a.2, UE1 delivers the animation data to the entity actuating avatar animation through RTP or data channel. The animating entity may be the MF or UE2.

And, for that D.3 of FIG. 23, and as an Alternative #2 thereof, by Network centric animation data generation features, at D.3b.1, the UE1 sends source data for animation data generation to the MF over RTP (audio, video, text) or data channel (text). At D.3b.2, the MF processes the received source data to generate animation data during the session. The animation data may be transformed from the source data (e.g., from audio to text, video to motion data), or the same as the source data. And at D.3b.3, the MF delivers animation data over RTP or data channel to the UE2 animating the base avatar. If network centric avatar animation is used, this step will be skipped. The animation data may be delivered to UE1 as well.

And so, at D.4 of FIG. 23, there is illustrated D.4. Avatar Animation features according to embodiments herein by which, based on the capability negotiation result in step A, the UE or network may animate the avatar. And as an Alternative #1 thereof, by UE centric avatar animation there is an alternative #1a where the UE1 does avatar animation such that at D.4a.1, the UE1 animates and renders the base avatar using animation data. The animation data is generated by UE1 in step D.3a.1.1. At D.4a.2, the UE1 delivers the animated and rendered avatar to UE2. The animated and rendered avatar (e.g., 3D or 2D video) may be delivered through RTP.

But as an alternative #1b, the UE2 does avatar animation such that at D.4b.1: UE2 animates and renders the base avatar using animation data. The animation data may be generated by the MF, following steps D.3b.1 to D.3b.2 and received by UE2 in step D.3b.3 or it may be generated by UE1 in step D.3a.1 and received by UE2 in step D.3a.2.

And as an alternative #2 thereof D.4, by network centric avatar animation, at D.4c.1, the MF animates and renders the UE1’s base avatar using animation data. The animation data may be generated by the MF, following step D.3b.1 and D.3b.2 or it may be received from UE1 following steps D.3a.1 and D.3a.2. At D.4c.2, the MF delivers the animated and rendered avatar to the UEs. In the figure, delivery to UE2 is shown as example. The animated and rendered avatar (e.g., 3D or 2D video) may be delivered through RTP. NOTE3: Rendering is not needed for 2D avatar.

And so, by embodiments there in, there is provided also an improved, innovated development of a mechanism for the avatar generation within an IMS architecture, required prior to the initialization of the real-time communication session.

Embodiments herein provide defines an IMS based Avatar generation session of the creation of a base representation avatar that may happen in the user device (the UE), in the Media Function (MF) in the Nmf of the IMS architecture or in an external Avatar Generator function. And there is provided a method for generating an avatar base representation format in the Media function of the Nmf of an IMS architecture, as part of a dedicated session prior to a real-time communication session. There is also provided a method for generating an avatar base representation format in the User Equipment (UE), as part of a dedicated session prior to a real-time communication session. And there is also provided a method for generating an avatar base representation format in an external Avatar Generator function that may be part of the Mobile Network Operator trusted domain or part of the untrusted data network, as part of a dedicated session prior to a real-time communication session.

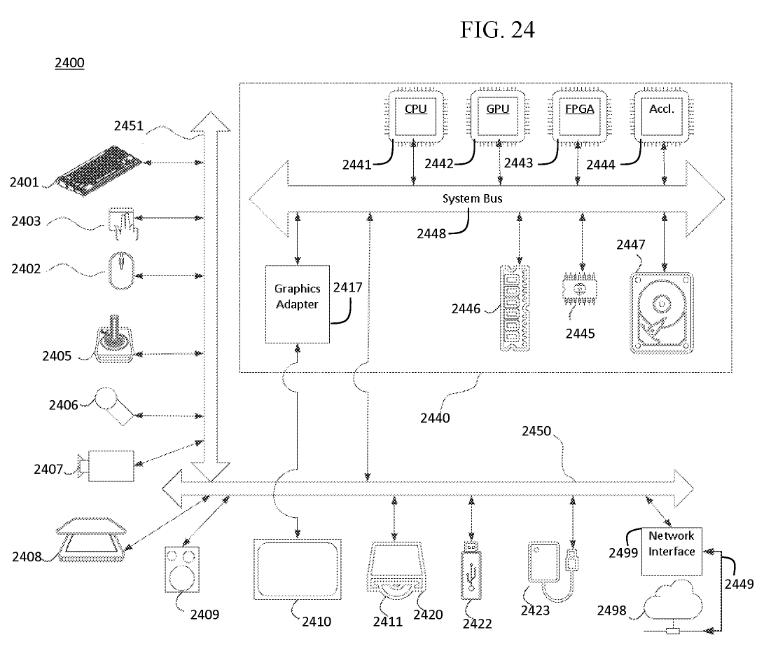

The techniques described above, can be implemented as computer software using computer-readable instructions and physically stored in one or more computer-readable media or by a specifically configured one or more hardware processors. For example, FIG. 24 shows a computer system 2400 suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 24 for computer system 2400 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 2400.

Computer system 2400 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 2401, mouse 2402, trackpad 2403, touch screen 2410, joystick 2405, microphone 2406, scanner 2408, camera 2407.

Computer system 2400 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 2410, or joystick 2405, but there can also be tactile feedback devices that do not serve as input devices), audio output devices (such as: speakers 2409, headphones (not depicted)), visual output devices (such as screens 2410 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system 2400 can also include human accessible storage devices and their associated media such as optical media including CD/DVD ROM/RW 2420 with CD/DVD 2411 or the like media, thumb-drive 2422, removable hard drive or solid state drive 2423, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 2400 can also include interface 2499 to one or more communication networks 2498. Networks 2498 can for example be wireless, wireline, optical. Networks 2498 can further be local, wide-area, metropolitan, vehicular and industrial, real-time, delay-tolerant, and so on. Examples of networks 2498 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks 2498 commonly require external network interface adapters that attached to certain general-purpose data ports or peripheral buses (2450 and 2451) (such as, for example USB ports of the computer system 2400; others are commonly integrated into the core of the computer system 2400 by attachment to a system bus as described below (for example Ethernet interface into a PC computer system or cellular network interface into a smartphone computer system). Using any of these networks 2498, computer system 2400 can communicate with other entities. Such communication can be uni-directional, receive only (for example, broadcast TV), uni-directional send-only (for example CANbusto certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 2440 of the computer system 2400.

The core 2440 can include one or more Central Processing Units (CPU) 2441, Graphics Processing Units (GPU) 2442, a graphics adapter 2417, specialized programmable processing units in the form of Field Programmable Gate Areas (FPGA) 2443, hardware accelerators for certain tasks 2444, and so forth. These devices, along with Read-only memory (ROM) 2445, Random-access memory 2446, internal mass storage such as internal non-user accessible hard drives, SSDs, and the like 2447, may be connected through a system bus 2448. In some computer systems, the system bus 2448 can be accessible in the form of one or more physical plugs to enable extensions by additional CPUs, GPU, and the like. The peripheral devices can be attached either directly to the core’s system bus 2448, or through a peripheral bus 2451. Architectures for a peripheral bus include PCI, USB, and the like.

CPUs 2441, GPUs 2442, FPGAs 2443, and accelerators 2444 can execute certain instructions that, in combination, can make up the aforementioned computer code. That computer code can be stored in ROM 2445 or RAM 2446. Transitional data can be also be stored in RAM 2446, whereas permanent data can be stored for example, in the internal mass storage 2447. Fast storage and retrieval to any of the memory devices can be enabled through the use of cache memory, that can be closely associated with one or more CPU 2441, GPU 2442, mass storage 2447, ROM 2445, RAM 2446, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, an architecture corresponding to computer system 2400, and specifically the core 2440 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 2440 that are of non-transitory nature, such as core-internal mass storage 2447 or ROM 2445. The software implementing various embodiments of the present disclosure can be stored in such devices and executed by core 2440. A computer-readable medium can include one or more memory devices or chips, according to particular needs. The software can cause the core 2440 and specifically the processors therein (including CPU, GPU, FPGA, and the like) to execute particular processes or particular parts of particular processes described herein, including defining data structures stored in RAM 2446 and modifying such data structures according to the processes defined by the software. In addition or as an alternative, the computer system can provide functionality as a result of logic hardwired or otherwise embodied in a circuit (for example: accelerator 2444), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for transcoding an avatar base representation format in an internet protocol (IP) multimedia subsystem (IMS) architecture, the method performed by one or more processors and comprising:
transcoding the avatar base representation format in a media function (MF) of the IMS architecture;
delivering the transcoded avatar base representation format to at least one user equipment (UE); and
generating animation data based on source data including any of audio, video, and text, and the animation data representing animation of a base avatar represented by the transcoded avatar base representation format.

2. The method according to claim 1, wherein the transcoded avatar base representation format is supported by the at least one UE.

3. The method according to claim 1, wherein transcoding the avatar base representation format comprises also transcoding animation controls in the MF of the IMS architecture.

4. The method according to claim 3, wherein the transcoded animation controls are in a mezzanine format.

5. The method according to claim 1, wherein the MF is of an Nmf service-based interface exhibited by the IMS architecture.

6. The method according to claim 1, wherein transcoding the avatar base representation format comprises transcoding between two avatar representation formats.

7. The method according to claim 6, wherein generating the animation data comprises transcoding between two animation formats associated to at least one of the two avatar representation formats.

8. A system for transcoding an avatar base representation format in an internet protocol (IP) multimedia subsystem (IMS) architecture, the system being implemented by one or more processors configured to:
transcode the avatar base representation format in a media function (MF) of the IMS architecture;
delivering the transcoded avatar base representation format to at least one of user equipment (UE); and
generate animation data based on source data including any of audio, video, and text, and the animation data representing animation of a base avatar represented by the transcoded avatar base representation format.

9. The system according to claim 8, wherein the transcoded avatar base representation format is supported by the at least one UE.

10. The system according to claim 8, wherein transcoding the avatar base representation format comprises also transcoding animation controls in the MF of the IMS architecture.

11. The system according to claim 10, wherein the transcoded animation controls are in a mezzanine format.

12. The system according to claim 8, wherein the MF is of an Nmf service-based interface exhibited by the IMS architecture.

13. The system according to claim 8, wherein transcoding the avatar base representation format comprises transcoding between two avatar representation formats.

14. The system according to claim 13, wherein generating the animation data comprises transcoding between two animation formats associated to at least one of the two avatar representation formats.

15. A non-transitory, computer-readable recording medium storing instructions, for transcoding an avatar base representation format in an internet protocol (IP) multimedia subsystem (IMS) architecture, which, when executed, control one or more processors to implement:
transcoding the avatar base representation format in a media function (MF) of the IMS architecture;
delivering the transcoded avatar base representation format to at least one user equipment (UE); and
generating animation data based on source data including any of audio, video, and text, and the animation data representing animation of a base avatar represented by the transcoded avatar base representation format.

16. The non-transitory, computer-readable recording medium according to claim 15, wherein the transcoded avatar base representation format is supported by the at least one UE.

17. The non-transitory, computer-readable recording medium according to claim 15, wherein transcoding the avatar base representation format comprises also transcoding animation controls in the MF of the IMS architecture.

18. The non-transitory, computer-readable recording medium according to claim 17, wherein the transcoded animation controls are in a mezzanine format.

19. The non-transitory, computer-readable recording medium according to claim 15, wherein the MF is of an Nmf service-based interface exhibited by the IMS architecture.

20. The non-transitory, computer-readable recording medium according to claim 15, wherein transcoding the avatar base representation format comprises transcoding between two avatar representation formats.
